(19) United States
(12) Patent Application Publication
(10) Pub. No.: US 2024/0284080 A1
(43) Pub. Date: Aug. 22, 2024

(54) SWITCHED WAVELENGTH OPTICAL RECEIVER FOR DIRECT-DETECTION METHODS AND SYSTEMS

(71) Applicants: FRANCOIS MENARD, TROIS-RIVIERES (CA); MARTIN BERARD, STE-CATHERINE-DE-LA-JACQUES-CARTIER (CA); PIERRE POTTIER, MONTREAL (CA); DAMIEN MICHEL, BROMONT (CA); JUSTIN ALEXANDER, GATINEAU (CA); SEBASTIEN GRAVEL, SAINT-LIN-LAURENTIDES (CA)

(72) Inventors: FRANCOIS MENARD, TROIS-RIVIERES (CA); MARTIN BERARD, STE-CATHERINE-DE-LA-JACQUES-CARTIER (CA); PIERRE POTTIER, MONTREAL (CA); DAMIEN MICHEL, BROMONT (CA); JUSTIN ALEXANDER, GATINEAU (CA); SEBASTIEN GRAVEL, SAINT-LIN-LAURENTIDES (CA)

(21) Appl. No.: 18/571,527

(22) PCT Filed: Jun. 30, 2022
(86) PCT No.: PCT/CA2022/051044

§ 371 Date: Dec. 18, 2023

Related U.S. Application Data
(60) Provisional application No. 63/221,138, filed on Jul. 13, 2021.
(60) Provisional application No. 63/217,387, filed on Jul. 1, 2021.

(51) Int. Cl. H04Q 11/00; H04B 10/272

(52) U.S. Cl. CPC H04Q 11/0005; H04B 10/272; H04Q 2011/0039; H04Q 2011/005

(57) ABSTRACT

Silicon photonics adds optical functionality to electronic integrated circuits allowing leveraging CMOS fabrication processes, integration of CMOS electronics discretely and integration of microelectromechanical systems (MEMS) or Micro-Opto-Electro-Mechanical-Systems (MOEMS) elements. Further, silicon photonics allows hybrid or monolithic integration of semiconductor photodetectors for optical receivers in conjunction with the passive silicon photonics and active elements such as semiconductor optical amplifiers (SOAs) and laser diodes (LDs) for coherent detection receivers for next generation systems. Accordingly, it would be beneficial to provide network designers with silicon photonic receivers for wavelength division multiplexed networks using direct or coherent detection which can dynamically select one or more channels from a large number of incoming channels whilst addressing the inherent issues that silicon photonics and other optical waveguide technologies exhibit such as polarisation dependency.

### CROSS-REFERENCE TO RELATED APPLICATIONS

This patent application claims the benefit of priority as a 371 National Phase Entry application of PCT/CA2022/051044 filed; which itself claims the benefit of priority from U.S. Provisional Patent Application No. 63/217,387 filed Jul. 1, 2021; and the benefit of priority from U.S. Provisional Patent Application No. 63/221,138 filed Jul. 13, 2021; the entire contents of which are incorporated herein by reference.

### FIELD OF THE INVENTION

This invention is directed to wavelength division multiplexed optical networks and more particularly to methods and systems of providing wavelength channel selection in a high-speed direct detection optical receiver at the optical network terminal of a passive optical network through the implementation of switched wavelength optical receivers for channel selection at the optical network terminal.

### BACKGROUND OF THE INVENTION

Optical networks can achieve extremely high bandwidth such that today they provide the enabling technology for the Internet and telecommunication networks which transmit the vast majority of all human and machine-to-machine information. Optical networks are also employed in other applications such as storage area networks and data centers. Such networks can include limited range local-area networks (LAN) or wide-area networks (WAN), which cross metropolitan and regional areas as well as long-distance national, international, and transoceanic networks. These optical networks typically employ optical amplifiers, lasers, and wavelength division multiplexing (WDM) to transmit large quantities of data.

Wavelength division multiplexing allows an optical fiber to support multiple concurrent optical signals each at a different wavelength. For example, coarse WDM (CWDM) networks support 18 wavelengths with a channel spacing of 20 nm over the wavelength range from 1271 nm to 1611 nm with a reach up to 150 km or so. In contrast, dense WDM (DWDM) networks can support 40, 80, or up to 160 wavelengths with a narrower channel spacing of 0.8/0.4 nm (100 GHz/50 GHz grid) in the wavelength ranges 1525 nm to 1565 nm (C band) and 1570 nm to 1610 nm (L band) exploiting optical amplification for link lengths of hundreds to thousands of kilometers.

However, such networks are typically planned with an optical network terminal (ONT) receiving optical signals upon a predetermined wavelength or wavelengths defined by an overall network architecture where the WDM functionality is upstream in the optical network. It would be beneficial in other network architectures for an ONT receiving multiple wavelength channel(s) to enable its optical receiver to dynamically select the wavelength channel(s) it is decoding, such that the network has additional resiliency, dynamic configurability, etc. Accordingly, it would be beneficial to provide network designers with a wavelength-selective optical receiver capable of selecting a single channel from these CWDM or DWDM channel plans.

Silicon Photonics is a promising technology for adding integrated optics functionality to integrated circuits by leveraging the economics of scale of the CMOS microelectronics industry. Some variants of Silicon Photonics may use other materials as the waveguide core such as silicon nitride (SixNy) and silicon oxynitride (SiOxN1-x) for example. Silicon Photonics in addition to leveraging CMOS based silicon fabrication processes also allows for the integration of control and driver CMOS electronics discretely or in conjunction with microelectromechanical systems (MEMS) elements to provide Micro-Opto-Electro-Mechanical-Systems (MOEMS).

Accordingly, it would be beneficial to exploit a technology such as silicon photonics to implement photonic integrated circuits (PICs) capable of dense or coarse WDM which can dynamically select one or more channels from the incoming stream to the downstream optical receiver. Further, silicon photonics allows hybrid or monolithic integration of semiconductor elements for optical receivers in conjunction with the silicon photonic waveguides such as semiconductor optical amplifiers (SOAs), laser diodes (LDs) for coherent detection and photodetectors. Finally, PICs can integrate transmitter functionality with the receiver functionality on the same integrated circuit.

It would therefore be beneficial to provide network designers with WDM receivers which can dynamically select one or more channels, which may be discontiguous, from a large number of incoming channels whilst addressing the inherent issues that silicon photonics and other optical waveguide technologies exhibit such as polarisation dependency.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to wavelength division multiplexed optical networks and more particularly to methods and systems of providing wavelength channel selection in a high-speed direct detection optical receiver at the optical network terminal of a passive optical network through the implementation of switched wavelength optical receivers for channel selection at the optical network terminal

In accordance with an embodiment of the invention there is provided a switched wavelength optical receiver comprising:
a plurality of wavelength selective optical switch (WSOS) elements coupled in series wherein the first WSOS element of the plurality of WSOS elements is coupled to the first output of a polarization management element and each sequential WSOS element in the plurality of WSOS elements has a free spectral range (FSR) equal to the FSR of the preceding WSOS of the plurality of first WSOS instances multiplied by a first constant; and
a photodetector coupled to the output of the last WSOS of the plurality of WSOS elements; wherein
each WSOS element of the plurality of WSOS elements is dynamically configurable between a first state and a second state such that the plurality of WSOS elements filter an incoming optical stream of a plurality optical signals having a predetermined channel spacing;
in the first state each WSOS element of the plurality of WSOS elements passes a first subset of those wavelengths coupled to it; and
in the second state each WSOS element of the plurality of WSOS elements passes a second subset of those wavelengths coupled to it.

In accordance with an embodiment of the invention there is provided a switched wavelength optical receiver comprising:
a polarisation element for generating a first output with a first polarisation and a second output with a second polarisation;
a plurality of first wavelength selective optical switch (WSOS) elements coupled in series wherein the first WSOS element of the plurality of first WSOS elements is coupled to the first output and each sequential first WSOS element in the plurality of first WSOS elements has a free spectral range (FSR) equal to the FSR of a preceding first WSOS element of the plurality of first WSOS elements multiplied by a constant;
a plurality of second wavelength selective optical switch (WSOS) elements coupled in series wherein the first second WSOS of the plurality of second WSOS elements is coupled to the second output and each sequential second WSOS in the plurality of second WSOS elements has an FSR equal to the FSR of a preceding second WSOS element of the plurality of second WSOS elements multiplied by the constant;
an output of the last first WSOS element of the plurality of first WSOS elements is coupled to a photodetector; and
an output of the last second WSOS element of the plurality of second WSOS elements is coupled to the photodetector.

In accordance with an embodiment of the invention there is provided a method comprising:
providing a polarisation element for generating a first output with a first polarisation and a second output with a second polarisation;
providing a plurality of first wavelength selective optical switch (WSOS) elements coupled in series wherein the first WSOS element of the plurality of first WSOS elements is coupled to the first output and each sequential first WSOS element in the plurality of first WSOS elements has a free spectral range (FSR) equal to the FSR of the preceding first WSOS of the plurality of first WSOS elements multiplied by a constant;
providing a plurality of second wavelength selective optical switch (WSOS) elements coupled in series wherein the first second WSOS element of the plurality of second WSOS elements is coupled to the second output and each sequential second WSOS element in the plurality of second WSOS elements has an FSR equal to the FSR of the preceding second WSOS element of the plurality of second WSOS elements multiplied by a second constant;
providing a photodetector; and
selectively coupling an incoming optical signal at a predetermined wavelength to the photodetector in dependence upon establishing each first WSOS element of the plurality of first WSOS elements into one of a first state and a second state and establishing the corresponding each second WSOS element of the plurality of second WSOS elements into the same one of the first state and the second state; wherein
an output of the last first WSOS of the plurality of first WSOS elements is coupled to the photodetector;
an output of the last second WSOS of the plurality of second WSOS elements is coupled to the photodetector; and
each first WSOS element of the plurality of first WSOS elements and each second WSOS element of the plurality of second WSOS elements passes a first subset of those wavelengths coupled to it in the first state and a second subset of those wavelengths coupled to it in the second state.

In accordance with an embodiment of the invention there is provided a switched wavelength optical receiver comprising:
an input port for receiving a plurality of N channels having a channel spacing of S GHz coupled to a first stage of a plurality of M stages of WSOS elements;
a photodetector coupled to the last stage of the plurality of M stages of WSOS elements; and
the plurality of M stages of WSOS elements for selecting a channel from the plurality of N channels; wherein
M and N are positive integers;

$$M = log 2 ( N ) ;$$

the first stage of the plurality of M stages of WSOS elements comprises a WSOS element having a FSR of S·R GHz where R=2\hat{ }I and I=1;
each of the M−1 remaining stages of the plurality of M stages of WSOS elements follow a predetermined sequence wherein each comprises a WSOS element having an FSR of S·R GHz where R=2\hat{ }I and I=2, . . . , M; wherein
the predetermined sequence is one where the sequence of I through the −1 remaining stages of the plurality of M stages of WSOS elements is non-sequential.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary switched wavelength optical receiver for direct-detection (SWORD) circuit exploiting polarisation diverse cascaded deinterleaving and optical switching to select the optical channel received by the high-speed photodetector.

FIG. 2 depicts an exemplary SWORD circuit exploiting polarisation splitting and polarisation rotation in conjunction with cascaded deinterleaving and optical switching to select the optical channel received by a high-speed photodetector.

FIG. 3 depicts an exemplary SWORD circuit exploiting polarisation splitting and polarisation rotation in conjunction with cascaded deinterleaving and higher radix optical switching elements to select the optical channel received by a high-speed photodetector.

FIG. 4A depicts an exemplary cascade of Mach-Zehnder deinterleavers in which an interferometric optical switching circuits is incorporated within a de-interleaving stage or a plurality of deinterleaving stages of a SWORD according to an embodiment of the invention.

FIG. 4B depicts an exemplary cascade of Mach-Zehnder deinterleavers in which an integrated optics MEMS optical switching circuit is incorporated within a deinterleaving stage or a plurality of deinterleaving within a SWORD according to an embodiment of the invention.

FIG. 5A depicts an exemplary switched wavelength optical receiver for direct-detection (SWORD) employing a cascade of wavelength selective optical switches (WSOS) according to an embodiment of the invention, wherein the optical switching function of each stage is embedded inside the deinterleaving function of that stage.

FIG. 5B depicts an exemplary switched wavelength optical receiver for direct-detection (SWORD) employing a cascade of wavelength selective optical switches (WSOS) which have their second input port connected to an additional optical switch and monitoring photodetector to provide feedback for circuit calibration, monitoring, and configuration.

FIG. 6 depicts an exemplary flow chart for controlling a WSOS under different fabrication tolerance scenarios.

FIG. 7 depicts a polarisation diverse SWORD exploiting WSOS based Mach-Zehnder deinterleavers with integrated optical switching according to an embodiment of the invention with improved polarisation extinction.

FIG. 8 depicts a polarisation diverse SWORD exploiting WSOS based Mach-Zehnder deinterleavers with integrated optical switching according to an embodiment of the invention making use of a polarisation combiner to clean up residual polarisation crosstalk and to reduce the number of a waveguides facing the high-speed photodetector to a single waveguide.

### DETAILED DESCRIPTION

The present invention is directed to wavelength division multiplexed optical networks and more particularly to methods and systems of providing wavelength channel selection in a high-speed direct detection optical receiver at the optical network terminal of a passive optical network through the implementation of switched wavelength optical receivers for channel selection at the optical network terminal.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It would be understood by one of skill in the art that various changes can be made in the function and arrangement of elements without departing from the scope of the invention as set forth in the claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers, or groups thereof and that the terms are not to be construed as specifying components, features, steps, or integers. Likewise, the phrase “consisting essentially of,” and grammatical variants thereof, when used herein is not to be construed as excluding additional components, steps, features integers or groups thereof but rather that the additional features, integers, steps, components, or groups thereof do not materially alter the basic and novel characteristics of the claimed composition, device or method. If the specification or claims refer to “an additional” element, that does not preclude there being more than one of the additional elements.

A “two-dimensional” waveguide, also referred to as a 2D waveguide or a planar waveguide, as used herein may refer to, but is not limited to, an optical waveguide supporting propagation of optical signals within a predetermined wavelength range which does not guide the optical signals laterally relative to the propagation direction of the optical signals.

A “three-dimensional” waveguide, also referred to as a 3D waveguide, a channel waveguide, or simply waveguide as used herein may refer to, but is not limited to, an optical waveguide supporting propagation of optical signals within a predetermined wavelength range which guides the optical signals laterally relative to the propagation direction of the optical signals.

A “wavelength division deinterleaver” (WDM D-INT or D-INT) as used herein may refer to, but is not limited to, an optical device for separating (deinterleaving) multiple optical signals of different wavelengths, cyclically repeating on a given free spectral range, which are received on a common optical waveguide, e.g. a waveguide forming part of a photonic integrated circuit or an optical fiber. For example, such a D-INT may exploit a Mach-Zehnder interferometer wherein a single input port carrying optical signals is split into 2 outputs each carrying optical signals at different predetermined wavelengths.

“Waveguide crosstalk” as used herein refers to, but is not limited to, optical cross-coupling between adjacent and non-adjacent optical waveguides.

“Crosstalk penalty” as used herein refers to, but is not limited to, inter-channel crosstalk stemming from multiple WDM signals within a passband of a channel reducing the wavelength extinction ratio of the wavelength division deinterleavers (D-INT).

A “photonic integrated circuit” (PIC) as used herein may refer to, but is not limited to, the monolithic integration of multiple integrated optics devices into a circuit formed upon a common substrate providing an optical routing and processing functionality. The PIC is fabricated using processing techniques at a wafer level, e.g., CMOS manufacturing flows, MEMS processing flows, etc.

Within the embodiments of the invention described below the optical waveguides exploit a silicon nitride core with silicon oxide upper and lower cladding, a SiO₂—Si₃N₄—SiO₂ waveguide structure. However, it would be evident that embodiments of the invention may also be employed in conjunction with other waveguide materials systems employing a CMOS compatible manufacturing process or semiconductor manufacturing processes upon silicon. These may include, but not be limited to:
a silicon core and silicon nitride upper and lower claddings, a Si₃N₄—Si—Si₃N₄ waveguide structure;
a silicon core with silicon oxide upper and lower claddings, a SOI waveguide, e.g., SiO₂—Si—SiO₂;
a doped silica core relative to undoped cladding, a SiO₂-doped_SiO₂—SiO₂, e.g. germanium doped (Ge) yielding SiO₂—Ge: SiO₂—SiO₂;
a silicon core and silicon oxynitride upper and lower claddings, a SiOₓN_{y}—Si—SiOₓN_{y} waveguide structure;
silicon oxynitride core with silicon oxide upper and lower claddings, a SiO₂—SiOₓN_{y}—SiO₂ waveguide structure;
polymer-on-silicon; and
doped silicon waveguides.

Additionally, waveguide structures without upper claddings may be employed.

However, it would be evident to one skilled in the art that the embodiments of the invention may be employed in conjunction with PICS employing a wide variety of other material systems that may include, but not be limited to:
ion exchanged glass;
ion implanted glass;
polymers;
indium gallium arsenide phosphide (InGaAsP);
indium phosphide (InP);
gallium arsenide (GaAs);
those employing other III-V materials;
those employing II-VI materials;
silicon (Si);
silicon germanium (SiGe); and
ferroelectric materials such as lithium niobate (LiNbO₃), lithium tantalate (LiTaO₃).

Further, whilst the embodiments of the invention are described and depicted with respect to a waveguide employing a core embedded within a cladding, a so-called buried waveguide, it would be evident that other waveguide geometries such as rib waveguide, diffused waveguide, ridge or wire waveguide, strip-loaded waveguide, slot waveguide, and anti-resonant reflecting optical waveguide (ARROW waveguide), photonic crystal waveguide, suspended waveguide, alternating layer stack geometries, sub-wavelength grating (SWG) waveguides and augmented waveguides (e.g. Si—SiO₂-Polymer). Further, whilst the embodiments of the invention are described and depicted with respect to a step-index waveguide it would be evident that other waveguide geometries such as graded index and hybrid index (combining inverse-step index and graded index) may be employed.

Owing to the intended use of the switched wavelength optical receiver for direct-detection (SWORD) to receive WDM signals sent across a fibre optic based passive optical network of a typical length of several kilometers in which it is impossible to expect the optical signal to have a known state of polarisation, it is expected that the SWORD would be able to provide consistent performance irrespective of the state of polarisation of the signal incoming onto it. Accordingly and as a common practice for integrated photonics in high index contrast waveguide platforms such as silicon and silicon nitride cores with waveguide geometries that are not perfectly square and inherently thus have different group indices for the transverse electric (TE) and transverse magnetic (TM) modes within the waveguides, the inventors have focused their embodiments of the SWORD and its subsequent improvements, on polarisation diverse implementations wherein a polarisation management element such as a polarisation splitter or a polarisation splitter rotator, is employed to separate the signal incoming on the SWORD into two polarisation components: Pol(1) and Pol(2). However, it would be evident that where optical waveguides with the same, or small differences within, the group indices of the TE and TM modes that embodiments of the invention may be implemented without the polarisation management element such that only one half, e.g., the upper portion or lower portion, of the subsequent photonic circuits described after the polarisation management component is required.

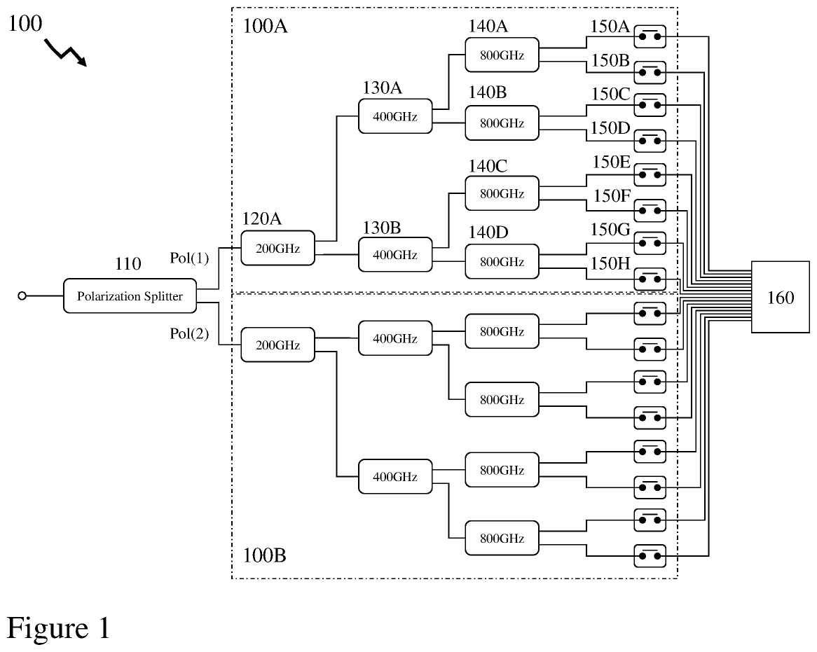

Referring to FIG. 1 there is depicted an exemplary switched wavelength optical receiver for direct detection (SWORD) 100 exploiting polarisation diverse cascaded deinterleaving and optical switching to select an optical channel to be received by an integrated high-speed photodetector. As depicted the SWORD 100 comprises a Polarization Splitter 110, a first D-INT-Switch 100A, a second D-INT-Switch 100B and a Photodetector (PD) 160. Polarization Splitter 110 receives the optical signals from a network and generates a pair of output signals, the upper, denoted as Pol(1), is coupled to the first D-INT-Switch 100A and the lower, denoted as Pol(2), is coupled to the second D-INT-Switch 100B. For example, Pol(1) may be transverse electric (TE) and Pol(2) transverse magnetic (TM) or vice-versa. It would be evident to one skilled in the art that additional embodiments of the SWORD 100 are possible, for example, according to a polarisation insensitive operation without a polarization splitter 110 and by replacing the polarization splitter 110 with a polarization splitter rotator and having both first D-INT-Switch 100A operate according to the fundamental mode (e.g. TE0) and second D-INT-Switch100B operate according to the first order odd mode (e.g. TE1) both of a common polarisation (i.e. the Transverse Electric polarisation).

An exemplary reference use case of a SWORD applies to a passive optical network broadcasting through an optical power splitter (typically a 1:32), four or eight wavelengths on the ITU Grid spaced apart according to the 100 GHz channel spacing, referring to the ITU-T G.989.2 standard (NG-PON2) in the L-band, where the SWORD would be tasked to select one or more of the following channels: 187.8, 187.7, 187.6, 187.5, 187.4, 187.3, 187.2 and 187.1 THz. It would be evident to one skilled in the art that other channel spacings, channel counts, etc., are possible such as, for example, those identified in the IEEE 802.3cn-2019 standard for 400GBASE-FR8, LR8 and ER8 in the O-band. In this instance, a SWORD would select one or a few channels among the following channels on an 800 GHz grid with channels at 235.4, 234.6, 233.8, 233, 231.4, 230.6, 229.8 and 229 THz. Further, embodiments of the invention can support selection of one or more channels from WDM streams based upon specifications providing 16, 32, 48 or 96 channels spaced apart by 50 GHz, 100 GHz, 400 GHz or 800 GHz respectively, or even spaced apart by as much as 20 nm as would be the case, for example, with CWDM4 or CWDM8.

Now referring to FIG. 1, a SWORD 100 applicable to the reference use case of an optical network terminal receiver for the NG-PON2 standard is depicted supporting selection of one channel from 8 channels upon a 100 GHz channel spacing. The SWORD 100 according to an embodiment of the invention employing a 3-stage cascade of Mach-Zehnder Deinterleavers (D-INT) with progressively doubling free spectral range (FSR) at each stage. The incoming stream is initially coupled to a Polarization Management Splitter 110 which provides a first output with a first polarisation, Pol(1), and a second output with a second polarisation, Pol(2). The first output of the Polarization Management Splitter 110 is connected to a 200 GHZ FSR D-INT which forms the first stage 120A. Each of its outputs is coupled to one of two instances of a 400 GHz FSR D-INT in the second stage formed by first and second 400 GHz D-INT FSR 130A and 130B. In the second stage, each one of the first and second 400 GHZ FSR D-INTs 130A and 130B are each connected to a pair of 800 GHz FSR D-INTs forming the third and final stage, which thereby comprises first to fourth 800 GHZ D-INTs 140A, 140B, 140C and 140D, respectively. Each of the first to fourth 800 GHZ D-INTs 140A-140D respectively has two outputs, thus collectively totaling 8 outputs, with a one-to-one correlation between an output and a channel of the 8 channels coupled to the SWORD 100 with the Pol(1) polarisation. This upper D-INT-Switch 100A comprising seven instances of D-INT units is replicated a second time as lower cascade 100B, this time operating upon the other polarisation from the Polarisation Management Splitter 110, Pol(2). SWORD 100 therefore comprises a total of 14 D-INTs. Each of the outputs from the first to fourth 800 GHZ D-INTs 140A, 140B, 140C and 140D respectively in each of the upper D-INT-Switch 100A and lower D-INT-Switch 100B are coupled to an optical gate (on-off switch) 150A to 150H within D-INT-Switch 100A and equivalent optical gates (unnumbered) within D-INT-Switch-100B. The output of each of these optical gates is routed on an optical waveguide, all of which converge upon on a high-speed Photodetector 160. Selection of a given channel in the input stream is performed by keeping all optical gates in the off-state except for those relating to the outputs from the third stage of upper cascade 100A and lower D-INT-Switch 100B which correspond to the selected channel. The summation of signals from the upper D-INT-Switch 100A and lower D-INT-Switch 100B is performed in free space between the termination of the fourteen optical waveguides, for example silicon nitride on silicon waveguides, onto a facet or facets of the PIC facets or surface gratings and a facet or intermediate optics of the high-speed Photodetector 160.

It would be evident to one skilled in the art that the operation of a SWORD 100A in reverse direction, omitting the high-speed Photodetector 160, and considering the outputs of the optical gates as individual inputs and the input of the first stage deinterleaver(s) as the final output(s), that the SWORD 100 could be operated as a wavelength blocker or programmable transmitter or programmable multiplexer.

The detailed embodiment of SWORD 100 as follows. First D-INT-Switch 100A comprising a 200 GHz free spectral range (FSR) D-INT 120A is coupled to first 400 GHz FSR D-INT 130A and second 400 GHz FSR D-INT 130B. The first 400 GHz FSR D-INT 130A is coupled to first and second 800 GHz FSR D-INTs 140A and 140B respectively whilst second 400 GHZ FSR D-INT 130B is coupled to third and fourth 800 GHZ FSR D-INTs 140C and 140D, respectively. The first 800 GHZ FSR D-INT 140A being coupled to PD 160 via first and second optical gates (OGs) 150A and 150B respectively, the second 800 GHz FSR D-INT 140B being coupled to PD 160 via third and fourth OGs 150C and 150D respectively, third 800 GHz FSR D-INT 140C being coupled to PD 160 via fifth and sixth OGs 150E and 150F respectively, and fourth 800 GHz FSR D-INT 140D being coupled to PD 160 via seventh and eighth OGs 150G and 150H respectively. In this embodiment, the optical gates (OGs) behave as ON-OFF optical switches.

Within an embodiment of the invention the OGs may be implemented normally-OFF and activated to be in the ON state. Accordingly, only one switch is required to be driven in each of the first D-INT-Switch 100A and second D-INT-Switch 100B respectively, to commonly select one channel.

Second D-INT-Switch 100B has a similar structure but operates upon the optical signals having polarisation Pol(2) whereas first D-INT-Switch 100A operates upon the optical signals having polarisation Pol(1). Accordingly, considering an input optical signal comprising 8 wavelengths on a 100 GHz grid, W1, W2, W3, W4, W5, W6, W7 and W8 then that component of these optical signals having polarisation Pol(1) at the SWORD 100 are routed to first D-INT-Switch 100A whilst the remaining component having polarisation Pol(2) are routed to the second D-INT-Switch 100B. Within the following description the operation of first D-INT-Switch 100A only is described for brevity as the operation of second D-INT-Switch 100B is the same.

At the 200 GHz FSR D-INT 120A stage, channels W1, W3, W5 and W7 are routed to first 400 GHZ FSR D-INT 130A whilst channels W2, W4, W6 and W8 are routed to second 400 GHZ FSR D-INT 130B. First 400 GHZ FSR D-INT 130A then routes channels W1, W3, W5 and W7 such that W1 and W5 are routed to first 800 GHZ FSR D-INT 140A whilst W3 and W7 are routed to second 800 GHZ FSR D-INT 140B. First 800 GHZ FSR D-INT 140A then routes channel W1 to first OG 150A and channel W5 to second OG 150B whilst second 800 GHZ FSR D-INT 140B then routes channel W3 to third OG 150C and channel W7 to fourth OG 150D.

Similarly, second 400 GHZ FSR D-INT 130B then routes channels W2, W4, W6 and W8 such that W2 and W6 are routed to third 800 GHZ FSR D-INT 140C whilst W4 and W8 are routed to fourth 800 GHZ FSR D-INT 140D. Third 800 GHZ FSR D-INT 140C then routes channel W2 to fifth OG 150E and channel W6 to sixth OG 150F whilst fourth 800 GHZ FSR D-INT 140D then routes channel W4 to seventh OG 150G and channel W8 to eighth OG 150H.

If the first to eighth OGs 150A to 150H are “open” then no optical signals are coupled to the PD 160. Accordingly, “closing” one of the first to eighth OGs 150A to 150H couples its associated wavelength, being W1, W5, W3, W7, W2, W6, W4, W8 respectively, to the PD 160. These optical signals being at Pol(1). Operating the associated OG within the second D-INT-Switch 100B couples the optical signals at the same channel with the other polarisation Pol(2) to the PD 160 wherein the PD 160 combines the optical signals from both polarisations. Accordingly, the SWORD 100 acts as a polarisation independent switched wavelength optical receiver which is capable of selecting one of 8 wavelengths (or wavelength bands) whilst the first and second D-INT-Switches 100A and 100B are polarisation dependent D-INTs with optical gates.

Within the structure depicted in FIG. 1 the 200 GHZ FSR D-INT 120A, first 400 GHZ FSR D-INT 130A and second 400 GHZ FSR D-INT 130B operate as cyclic deinterleavers. It would be evident that alternate architectures may be employed for the D-INT portion using integrated optics band filters etc. such that the wavelengths are separated in a different sequence, e.g., W1-W4 from W5-W8 initially, but such bandpass filters are very challenging to fabricate in integrated optics owing the lack of a guard band between W4 and W5. Platforms such as silicon photonics can take advantage of the cyclic property of Mach-Zehnder Interferometer in a cascade of Mach-Zehnder deinterleavers (D-INT) with free spectral ranges aligned to the spacing (e.g., 100 GHz) between the channels to select from. Accordingly, the architecture depicted is suited to monolithic integration where all functionality is integrated onto the same photonic integrated circuit (PIC).

It would be evident that the SWORD 100 can be expanded to include fourth, fifth, sixth stages etc. such that the SWORD 100 operates upon 16, 32, 64, etc. channels. Similarly, the FSR of the D-INTs within each stage of an 8-channel SWORD 100 with a 50 GHz channel spacing, may be 100 GHz, 200 GHz and 400 GHz. The same SWORD 100 with a 50 GHz channel spacing could be extended to 16 channels by adding an additional D-INT stage with an 800 GHz FSR and further extended to 32 channels by adding yet another stage with an FSR of 1.6THz etc. Alternatively, the first stage D-INTs may operate 50 GHz or 400 GHz with subsequent stages doubling in FSR for supporting other grid plans. Similarly, operation of the SWORD 100 may be solely in a single telecommunications band, such as O-band, E-band, S-band, C-band, and L-band for example or span two more telecommunications bands such as C-band and L-band for example.

Whilst a reverse frequency sequence may be implemented within a PIC starting with an initial 800 GHZ FSR D-INT in each of the first and second Switch-D-INT 100A and 100B and ending with multiple 200 GHZ FSR D-INTs this is generally not employed as it would require many instances of the D-INTs with smaller FSR and thus many components of the largest size and highest fabrication tolerance requirements, thereby impacting die yield and costs. Accordingly, the architecture in FIG. 1 has higher numbers of the lower tolerance components (e.g., 800 GHZ FSR D-INTs) than higher tolerance components (e.g., 200 GHz FSR D-INTs).

The high-speed photodetector PD 160 may be hybrid integrated, monolithically integrated, or an external component coupled to the outputs of the array of optical gates via PIC waveguides, PIC waveguide facets, surface gratings, optical fibers, optical fiber ribbon(s), photonic wirebonds, etc. PD 160 may, for example, be a reverse biased p-i-n diode or an avalanche photodiode. Optionally, PD 160 may be an array of two or more balanced photodiodes coupled to subsets of the arrayed outputs from the optical gates which are then electrically combined. While intensity-modulation direct-detection is the aim of the SWORD, the inventors do not preclude the applicability of the invention to more advanced forms of optical detection such as Optical Duo-Binary, Kramers-Kronig, etc.

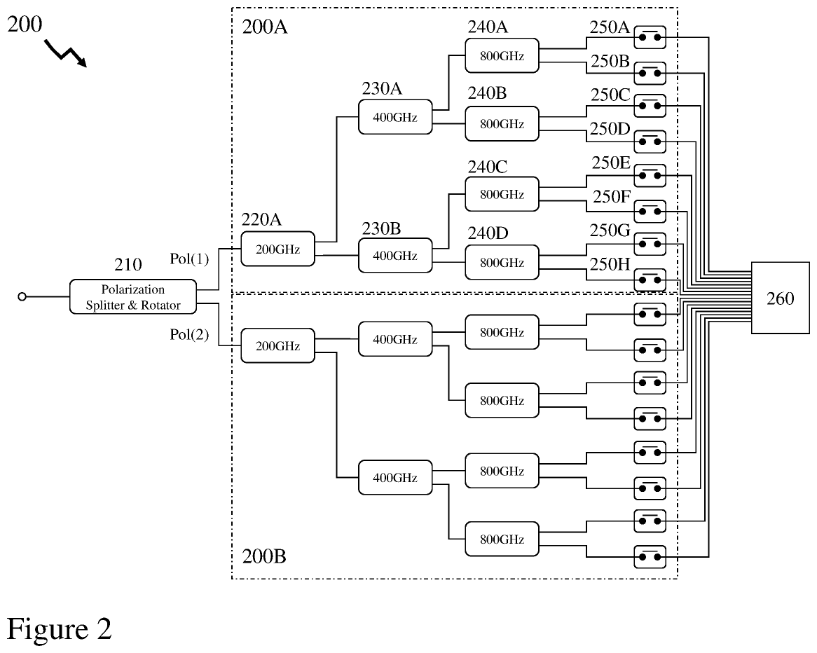

Referring to FIG. 2 there is depicted an alternate switched wavelength optical receiver for direct-detection (SWORD) 200, which comprises a Polarization Splitter and Rotator 210, a first D-INT-Switch 200A, a second D-INT-Switch 200B and a Photodetector (PD) 260. Polarization Splitter and Rotator 210 receives the optical signals from a network and generates a pair of output signals, the upper, denoted as Pol(1), is coupled to the first D-INT-Switch 200A and the lower, denoted as Pol(2), is coupled to the second D-INT-Switch 200B. However, in contrast to SWORD 100 with Polarisation Management Splitter 110, where Pol(1) may be transverse electric (TE) and Pol(2) transverse magnetic (TM) or vice-versa, then with Polarisation Splitter and Rotator 210 Pol(1) may be transverse electric (TE) or transverse magnetic (TM) and Pol(2) is the same. In this manner, the SWORD 200 apart from the Polarization Splitter and Rotator 210 operates upon a single polarisation within the first D-INT Switch 200A and second D-INT Switch 200B, respectively.

First D-INT-Switch 200A comprises a 200 GHZ FSR D-INT 220A coupled to first 400 GHZ FSR D-INT 230A and second 400 GHZ FSR D-INT 230B. The first 400 GHZ FSR D-INT 230A is coupled to first and second 800 GHZ FSR D-INTs 240A and 240B respectively whilst second 400 GHZ FSR D-INT 230B is coupled to third and fourth 800 GHZ FSR D-INTs 240C and 240D, respectively. The first 800 GHZ FSR D-INT 240A being coupled to PD 260 via first and second optical gates (OGs) 250A and 250B respectively, the second 800 GHZ FSR D-INT 240B being coupled to PD 260 via third and fourth optical gates (OGs) 250C and 250D respectively, third 800 GHZ FSR D-INT 240C being coupled to PD 260 via fifth and sixth optical gates (OGs) 250E and 250F respectively, and fourth 800 GHZ FSR D-INT 240D being coupled to PD 260 via seventh and eighth optical gates (OGs) 250G and 250H respectively.

Second D-INT-Switch 200B has a similar structure but operates upon the optical signals having polarisation Pol(2) whereas first D-INT-Switch 200A operates upon the optical signals having polarisation Pol(1). Accordingly, considering an input optical signal comprising 8 wavelengths on a 100 GHz grid, W1, W2, W3, W4, W5, W6, W7 and W8 then that component of these optical signals having polarisation Pol(1) at the SWORD 200 are routed to first D-INT-Switch 200A whilst the remaining component having polarisation Pol(2) are routed to the second D-INT-Switch 200B. Within the following description the operation of first D-INT-Switch 200A is described for brevity as the operation of second D-INT-Switch 200B is the same.

At 200 GHZ FSR D-INT 220A channels W1, W3, W5 and W7 are routed to first 400 GHZ FSR D-INT 230A whilst channels W2, W4, W6 and W8 are routed to second 400 GHZ FSR D-INT 230B. First 400 GHZ FSR D-INT 230A then demultiplexes channels W1, W3, W5 and W7 such that W1 and W5 are routed to first 800 GHZ FSR D-INT 240A whilst W3 and W7 are routed to second 800 GHZ FSR D-INT 240B. First 800 GHZ FSR D-INT 240A then demultiplexes channel W1 to first OG 250A and channel W5 to second OG 250B whilst second 800 GHZ FSR D-INT 240B then demultiplexes channel W3 to third OG 250C and channel W7 to fourth OG 250D.

Similarly, second 400 GHZ FSR D-INT 230B then demultiplexes channels W2, W4, W6 and W8 such that W2 and W6 are routed to third 800 GHZ FSR D-INT 240C whilst W4 and W8 are routed to fourth 800 GHZ FSR D-INT 240D. Third 800 GHZ FSR D-INT 240C then demultiplexes channel W2 to fifth OG 250E and channel W6 to sixth OG 250F whilst fourth 800 GHZ FSR D-INT 240D then demultiplexes channel W4 to seventh OG 250G and channel W8 to eighth OG 250H.

If the first to eighth OGs 250A to 250H are “open” or “off” then no optical signals are coupled to the PD 260. Accordingly, “closing” one of the first to eighth OGs 250A to 250H couples its associated wavelength, being W1, W5, W3, W7, W2, W6, W4, W8 respectively, to the PD 260. These optical signals being at Pol(1). Operating the associated OG within the second D-INT-Switch 200B couples the optical signals at the same channel with the other polarisation Pol(2) to the PD 260 wherein the PD 260 combines the optical signals from both polarisations. Accordingly, the SWORD 200 acts as a polarisation independent switched wavelength optical receiver which is capable of selecting one of 8 wavelengths (or wavelength bands) whilst the first and second D-INT-Switches 200A and 200B are polarisation dependent D-INTs with optical gates.

However, in contrast to SWORD 100 in FIG. 1 the polarisations Pol(1) and Pol(2) are the same such that the pair of Switch-D-INTs are only required to operate in a single polarisation whereas in SWORD 100 the pair of Switch-D-INTs operate on different polarisations. That portion of SWORD 200 required to efficiently handle dual polarisations is reduced due to the Polarisation Splitter and Rotator 210. Accordingly, the Polarisation Splitter and Rotator 210 splits the received optical signals into TE and TM before rotating the TM polarisation to TE to provide Pol(2) to the second Switch-D-INT 200B whilst the TE polarisation passes directly as Pol(1) to the first Switch-D-INT 200A. It would be evident that the reverse is also possible with the TM being passed directly from the Polarisation Splitter and Rotator 210 whilst TE is rotated to TM prior to being coupled to the Switch-D-INT.

Within the structure depicted in FIG. 2 the 200 GHZ FSR D-INT 220A, first 400 GHZ FSR D-INT 230A and second 400 GHZ FSR D-INT 230B operate as cyclic demultiplexers (deinterleavers). It would be evident that alternate architectures may be employed for the D-INT portion using band filters etc. such that the wavelengths are separated in a different sequence, e.g., W1-W4 from W5-W8 initially, but such bandpass filters are less compatible with monolithic integration using a platform such as silicon photonics than deinterleavers or cyclic D-INTs. Accordingly, the architecture depicted is suited to monolithic integration.

Whilst a reverse frequency sequence may be implemented within a PIC starting with an initial 800 GHZ FSR D-INT in each of the first and second Switch-D-INT 200A and 200B and ending with multiple 200 GHZ FSR D-INTs this is generally not employed as it requires that the more fabrication sensitive elements, the D-INTs with narrower frequency operation (e.g. 200 GHz versus 800 GHz), are required in higher quantities thereby impacting die yield and costs. Accordingly, the architecture in FIG. 2 has higher numbers of the lower tolerance components (e.g., 800 GHZ FSR D-INTs) than higher tolerance components (e.g., 200 GHz FSR D-INTs).

The PD 260 may be hybrid integrated, monolithically integrated, or an external component coupled to the outputs of the array of switches via optical fibers, optical fiber ribbon(s), free space optics etc. PD 260 may, for example, be a reverse biased p-i-n diode or an avalanche photodiode. Optionally, PD 260 may be an array of two or more photodiodes coupled to subsets of the arrayed outputs from the optical gates which are then electrically combined.

It would be evident that the SWORD 200 can be expanded to include fourth, fifth, sixth stages etc. such that the SWORD 200 operates upon 16, 32, 64, etc. channels. Similarly, the FSR of the D-INTs within each stage of SWORD 200 may be 100 GHz, 200 GHz and 400 GHz for example to support channels at 50 GHz and that subsequent stages provide 800 GHz, 1.6THz etc. Alternatively, the first stage D-INTs may operate 50 GHz or 400 GHz with subsequent stages doubling in FSR for supporting other grid plans. Similarly, operation of the SWORD 200 may be solely in a single telecommunications band, such as O-band, E-band, S-band, C-band, and L-band for example or within two more telecommunications bands such as C-band and L-band for example.

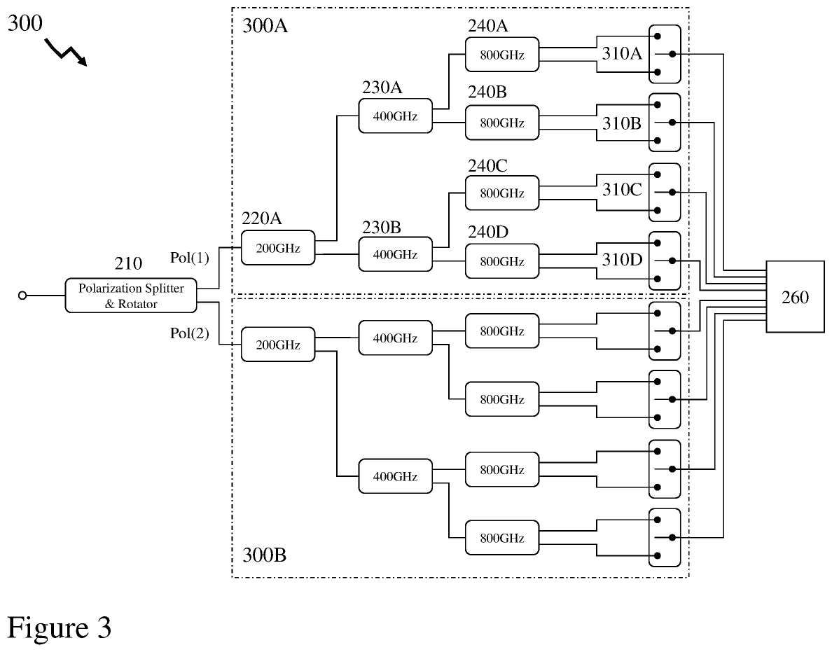

Now referring to FIG. 3 there is depicted an exemplary switched wavelength optical receiver, SWORD 300, exploiting polarisation splitting and polarisation rotation in conjunction with deinterleaving and higher order optical switching elements to select the optical channel received by the high-speed photodetector. As depicted SWORD 300 comprises Polarization Splitter and Rotator 210, a first D-INT-Switch 300A, a second D-INT-Switch 300B and Photodetector (PD) 260. Within each of the first and second D-INT-Switches 300A and 300B the D-INT portion is as described in respect of FIG. 2. However, the 8 OGs at the outputs of the D-INT portion in each have been replaced with 4 2×1 Optical Switches 310A to 310D, respectively. Accordingly, each of the 4 2×1 Optical Gates 310A to 310D respectively can select an output from the pair of outputs of the 800 GHZ FSR D-INT it is coupled to or block each. As such each 2×1 Optical Gate has three states, one blocking both outputs of the 800 GHZ FSR D-INT, a second coupling a first output of the 800 GHZ FSR D-INT to the PD 260 and a third coupling the second output of the 800GHx D-INT to the PD 260. It would be evident that if the network control were such that the two wavelengths at each 800 GHZ FSR D-INT never could be provisioned to the SWORD 300 then the 2×1 Optical Gate could be replaced with a conventional 2×1 optical switch.

An example of a 2×1 Optical Gate providing such functionality may be a microelectromechanical systems (MEMS) optical switching element such as described by the inventors within U.S. Pat. No. 10,466,421 entitled “Methods and System for Wavelength Tunable Optical Components and Sub-Systems”, U.S. Pat. No. 10,694,268 entitled “Photonic Switches, Photonic Switching Fabrics and Methods for Data Centers”, and World Patent Application PCT/CA2019/000,156 entitled “Structures and Methods for Stress and Gap Mitigation in Integrated Optics Microelectromechanical Systems.” The entire contents of these patents and patent specifications being incorporated herein by reference.

Alternatively, the 2×1 Optical Gate could be a SWORD element to select either of the two wavelengths or block them both.

It would be evident that this principle can be extended further, such that considering the exemplary structures depicted in FIGS. 1 to 3 respectively 4 OGs or 2 2×1 Optical Gates may be replaced with a 4×1 Optical Gate such that a pair of 4×1 Optical Gates are employed for all 8 channels. Optionally, the 8 OGs or 4 2×1 Optical Gates may be replaced with a single 8×1 Optical Gate.

Within the embodiments depicted in FIGS. 1 to 3 the SWORDs have been described and depicted with respect to a single PD and receipt of a single wavelength channel. However, it would be evident that the SWORD may employ 2, 3, or more PDs wherein the optical gate/switching structure after the D-INT for each polarisation becomes an NxM structure such that the N optical channels, e.g. 8 as depicted in FIGS. 1 to 3 respectively, can be coupled to M PDs wherein the remaining N-M channels are blocked.

The Switched Wavelength Optical Receivers for Direct-Detection (SWORD) employing a cascade of Mach-Zehnder deinterleavers (D-INTs) has up to now been described with a single input port and as many output ports as the number of channels within the channel plan of the network to which the SWORD is connected. Further, all output ports converge onto a single high-speed photodetector while being intermediated by an optical gate or higher-radix optical gate to essentially block all but the single channel of interest, noting that the channel of interest may be the sum of its Pol(1) and (Pol(2) components in a polarization diverse embodiment.

This requires therefore for multiple waveguides to converge onto the same high-speed photodetector where their outputs are “integrated” or “combined” by being coupled to the high-speed photodetector, for example, through their divergence in free space from their termination at the PIC edge facet(s) (or surface grating(s) etc.), onto the active area of the high-speed photodetector, noting that the higher the speed, the smaller the active area of the high-speed photodetector. The number of possible waveguides that can be combined is therefore constrained by the size of the active area of such high-speed photodetectors or by the clear aperture of a lens or optical elements disposed between the waveguides at the output of the SWORD and the high-speed photodetector.

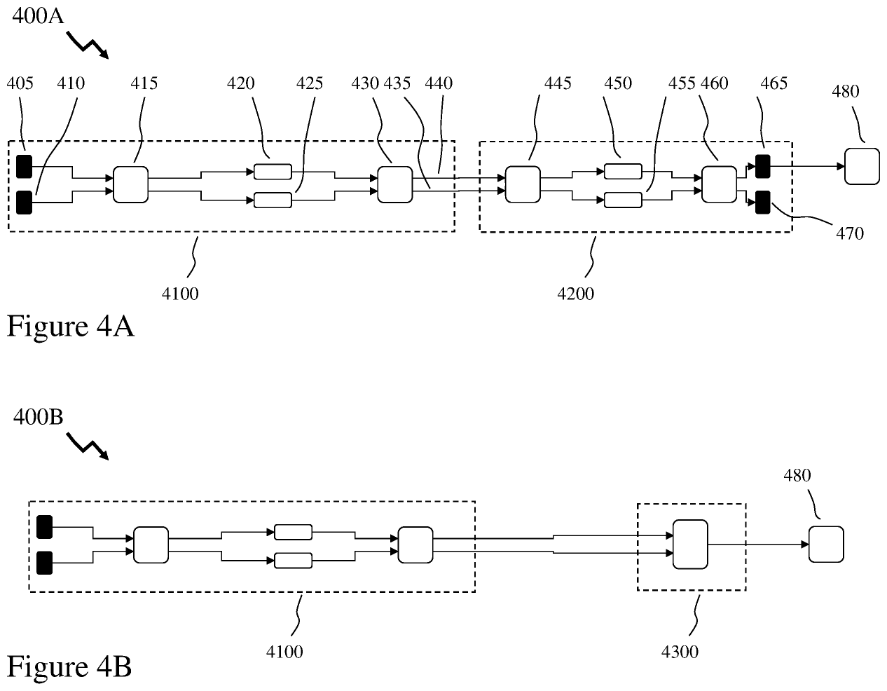

Accordingly, it would be advantageous to reduce the size of the “tree” of D-INTs to reduce the size of the SWORD overall, reduce the number of waveguides converging on the high-speed photodetector, and reduce the number of D-INTs required thereby reducing die dimensions. In FIG. 4A, the inventors have pioneered the concept of implementing optical switching between deinterleaving stages of a SWORD by way of an additional instance of a balanced MZI used as a 2×2 optical switch. In FIG. 4B, the inventors have pioneered the concept of introducing an integrated-optics micro-electro-mechanical-system (IO-MEMS) 2×1 optical switch between the D-INT stages within the “tree”, especially at the output of the D-INT with the smallest FSR, which segregates odd from even channels to maximize the adjacent channel isolation (which contributes most to the crosstalk penalty of a system with few channels) owing to the non-interferometric behaviour of an IO-MEMS 2×1 optical switch, which thus has inherently superior wavelength extinction ratio over a balanced MZI switch.

Now referring to FIG. 4A a D-INT Switch unit cell with an external Optical Selector (OS) is depicted. A SWORD based on a cascade of D-INT with external Optical Selector (OS) would employ a plurality of such depicted D-INT Switch unit cells. Accordingly, the D-INT-Switch 400A comprises a Mach-Zehnder De-Interleaver 4100 in series with a PIC Switch 4200. The PIC switch 4200 is made from an unbalanced MZI which provides a switch response which is more wavelength insensitive than engineering a cross or bar stage inside a balanced MZI, such as being the case within the D-INT Switches, thus enhancing the wavelength extinction ratio at each stage of the SWORD. However, this comes at the expense of increasing the PIC footprint and the number of MZIs. As examples, a PIC switch may be inserted between the 1^{st} stage and the 2^{nd} stage only of a four-channel SWORD or between both the first stage and the second stage as well as between the second stage and the third stage in the case of an 8-channel SWORD. As depicted the cascade of Mach-Zehnder deinterleavers 4100 comprises a first input 405, second input 410, input coupler 415, upper arm 420, lower arm 425 and output coupler 430 providing first and second outputs 435 and 440, respectively. Accordingly, the input coupler 415 and output coupler 430 are 50:50 couplers, such as 2×2 multimode interference (MMI) couplers or 2×2 directional couplers wherein a path imbalance is provided between the upper arm 420 and lower arm 425 connecting the input coupler 415 to the output coupler 430. Within FIGS. 4A and 4B the D-INT is a photonic circuit element based upon an unbalanced Mach-Zehnder interferometer wherein either arm or both arms are employed for bias adjustment, without seeking to deliberately flip the output ports of 4100, leaving it to PIC switch 4200 to do so.

It is noted that in the case of FIG. 4A that there is no need to have both output coupler 430 and input coupler 445 as it would be possible to connect the outputs 435 and 440 of the first D-INT directly to the two arms of the PIC switch 4200, thus bypassing its input 2×2 coupler 445. The path imbalance is established according to the FSR of each stage in the cascade of Mach-Zehnder deinterleavers 4100. The result is that an incoming WDM channel stream is deinterleaved according to the FSR of each stage in the cascade of Mach-Zehnder deinterleavers 4100 to a first stream upon first output 435 and a second stream upon second output 440.

For example, if D-INT-Switch 400A has an FSR of 200 GHz and receives channels L(1) to L(8) on a 100 GHz channel spacing then wavelengths L(S) where S=1,3,5,7 are coupled to the first output 435 and the remaining wavelengths L(T) where T=2,4,6,8 are coupled to the second output 440. The first and second outputs 435 and 440 are then coupled to PIC Switch 4200 which comprises a balanced Mach-Zehnder interferometer with first coupler 445 and second coupler 460 together with first arm 450 and second arm 455 yielding third output 465 and fourth output 470. The third output 465 being coupled to subsequent Optical Circuit 480 which may, for example, be another D-INT-Switch 400A with different FSR or a photodiode such as a PD forming Optical Circuit 480 in FIGS. 4A and 4B. Accordingly, first coupler 445 and second coupler 460 are 50:50 couplers, such as 2×2 multimode interference (MMI) couplers or 2×2 directional couplers, wherein establishing the appropriate phase imbalance between the first arm 450 and second arm 455 routes either the optical signals upon the first output 435 of the cascade of Mach-Zehnder deinterleavers 4100 to the third output 465 or the optical signals upon the second output 440 of the cascade of Mach-Zehnder deinterleavers 4100 to the third output 465. In either instance the signals on the other output from the cascade of Mach-Zehnder deinterleavers 4100 are routed to fourth output 470 Accordingly, by appropriately setting the relative phase bias between the first arm 450 and the second arm 455 the PIC Switch 4200, although a 2×2, acts like a 2×1 switch, routing the appropriate output from the cascade of Mach-Zehnder deinterleavers 4100 to the Optical Circuit 480. Optionally, the signal recovered on output port 470 may be sent to a monitoring photodetector (not show) for purposes of facilitating circuit calibration, monitoring, and configuration.

Optionally, PIC Switch 4200 may be an unbalanced Mach-Zehnder interferometer rather than a balanced Mach-Zehnder interferometer. Optionally PIC Switch 4200 may be a 2×1 directional coupler switch, a 2×1 digital optical Y-branch switch, or other PIC based optical switch.

Accordingly, D-INT-Switch 400A may be cascaded with different FSRs for the Mach-Zehnder deinterleavers 4100 to provide multi-stage D-INT Switches.

Now referring to FIG. 4B there is depicted an exemplary D-INT-Switch 400B comprising a Mach-Zehnder deinterleaver 4100 with a 2×1 microelectromechanical systems (MEMS) switch 4300 to select the appropriate output from the Mach-Zehnder deinterleaver 4100 to route to the Optical Circuit 480. The MEMS switch may employ a microoptoelectromechanical systems (MOEMS) such as described by the inventors within U.S. Pat. No. 10,466,421 entitled “Methods and System for Wavelength Tunable Optical Components and Sub-Systems”, U.S. Pat. No. 10,694,268 entitled “Photonic Switches, Photonic Switching Fabrics and Methods for Data Centers”, and World Patent Application PCT/CA2019/000,156 entitled “Structures and Methods for Stress and Gap Mitigation in Integrated Optics Microelectromechanical Systems.” The entire contents of these patents and patent specifications being incorporated herein by reference.

A benefit of using a MEMS switch 4300 relative to PIC Switch 4200 may be obtained within some system environments where the wavelength range is broad as the MEMS Switch 4300 is inherently broadband relative to interference-based PIC Switches 4200, e.g. Mach-Zehnder interferometer or directional coupler based switches, where there is a wavelength dependence to these within the band of interest. This is particularly important for the D-INT-Switch with the lowest FSR as it has the highest impact of the adjacent channel isolation and the associated crosstalk penalty this introduces. Accordingly, in some embodiments of the invention with a D-INT-Switch comprising a cascade of deinterleaver instances, a portion of them, for example those with lower FSRs, may employ MEMS Switch-based D-INT-Switch such as depicted within 400B in FIG. 4B whilst another portion of them, for example those with higher FSRs, may employ PIC Switch-based D-INT Switches such as depicted within D-INT-Switch 400A in FIG. 4A. In other embodiments all D-INTs may be one design, e.g., D-INT-Switch 400A or D-INT-Switch 400B.

Within other embodiments of the invention the MEMS Switch 4300 may be replaced with an optical switch exploiting another optical switching technologies including those based upon PIC, fiber optic or mechanical optical switching technologies. PIC switch elements may exploit, for example, Mach-Zehnder Interferometers (MZIs), directional couplers etc. or where a broad wavelength response digital optical switches may be employed based upon Y-junctions and X-junctions, respectively.

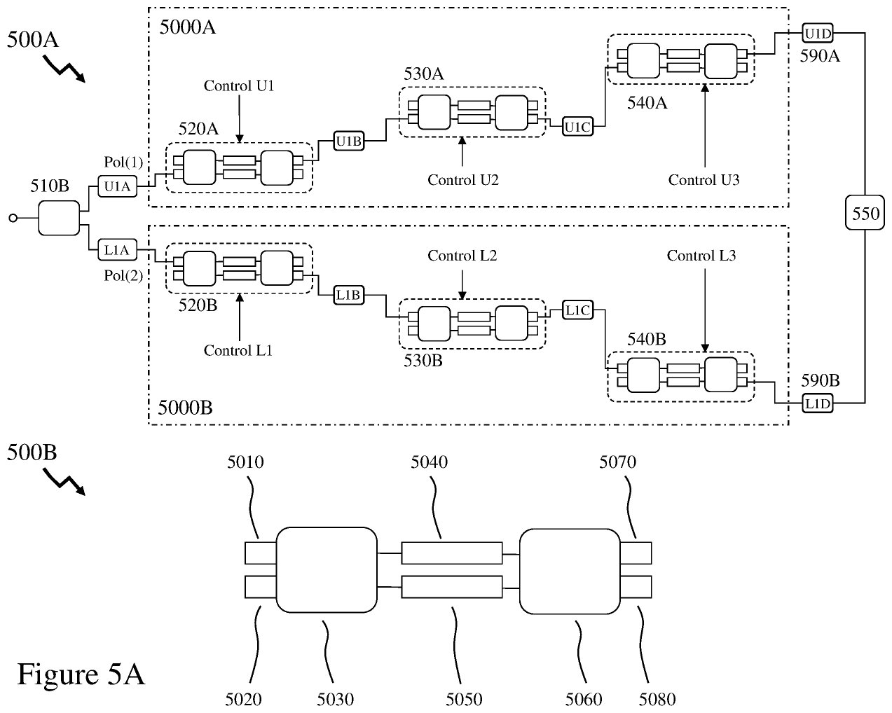

Nonetheless, the previous embodiments described in FIGS. 4A and 4B where the optical switching function is external to the D-INTs exhibit a drawback of increased PIC footprint of the complete SWORD and the inventors have subsequently focused their attention searching how to attain as good performance as with D-INTs paired with external optical switches, by way of introducing the concept of a wavelength selective optical switch (WSOS) in which optical switching function is embedded inside the D-INTs. WSOS structures and SWORDs employing them are described below with respect to FIGS. 5A to 8, respectively.

The inventors have established that using silicon nitride as a material for waveguide core can provide a lower effective index and an increased delocalized mode compared to silicon waveguides. This provides increased resilience to random phase noise introduced by random variation in the micro-fabrication process when exploiting high-efficiency thermo-optic phase shifters.

The inventors note that whilst the D-INTs described within embodiments of the invention may be explicitly or implicitly combined with thermo-optic or thermo-mechanical-optic phase shifters, their primary use would be to thermally compensate for fabrication imperfections and not to make use of them for purposes of doubling the free spectral range of the D-INT. Within other embodiments of the invention phase shifters may be implemented through mechanisms other than thermo-optic shifting according to the optical waveguide technology. Such mechanisms may include, but not be limited to, electro-optic, magneto-optic, physical path adjustment through MEMS for example, or refractive index adjustment through adjustment of the waveguide structure. Adjustment of the waveguide structure being, for example, by MEMS based actuation of an element disposed close to the core of optical waveguide.

The inventors sought to implement the WSOS with embedded optical switching functionality to have a wavelength extinction ratio comparable to the level of performance obtainable when employing an optical switch external to the D-INTs. Accordingly, the inventors describe below embodiments of switched wavelength optical receiver for direct-detection (SWORD) circuits comprising a cascade of wavelength selective optical switches (WSOS) according to different ways of implementing polarisation diverse operation, known to be critically important for optical receivers.

In FIG. 5A, the Inventors describe an embodiment of the invention with respect to a wavelength selective optical switch (WSOS), making it possible to reduce the number of D-INTs in a SWORD to only one instance of each Free Spectral Range (FSR) by enabling each D-INT to also integrate the capability to be dynamically re-configured into a cross or a bar state.

Now referring to FIGS. 5A and 5B there are depicted exemplary switched wavelength optical receivers for direct detection (SWORDs 500A and 500B respectively). First exemplary switched wavelength optical receiver, SWORD 500A exploits polarization diversity in conjunction with cascades of wavelength selective optical switch (WSOS) elements for each of the polarisations. Pol(1) and Pol(2), coupled to them from an initial polarisation element 510B, such as Polarisation Management Splitter 110 in FIG. 1 or Polarisation Splitter and Rotator 210 in FIG. 2 according to an embodiment of the invention. Second SWORD 500C in FIG. 5B depicts the first SWORD 500A with additional monitoring ports which exploit the second input of some or all WSOS connected to an additional optical switch and a monitoring photodetector to facilitate circuit calibration, monitoring, and configuration.

Now referring to FIG. 5A there is depicted a polarization diverse first SWORD 500A exploiting cascades of wavelength selective optical switch (WSOS) elements according to an embodiment of the invention. SWORD 500A comprises Polarisation Element 510B, Upper Circuit 5000A, Lower Circuit 5000B and PD 550. Upper Circuit 5000A comprises first Upper WSOS 520A, second Upper WSOS 530A and third Upper WSOS 540A which act upon the upper output U1A of the Polarisation Element 510B. Lower Circuit 5000B comprises first Lower WSOS 520B, second Lower WSOS 530B and third Lower WSOS 540B which act upon the lower output L1A of the Polarisation Element 510B. Within other embodiments of the invention PD 550 may be a subsequent optical circuit, optical link, optical component(s), etc. rather than terminating to an electrical output.

Accordingly, each of the Upper Circuit 5000A and Lower Circuit 5000B generates a single wavelength output at the Upper Output UID 590A and Lower Output LID 590B for the polarisation it processes which are then coupled to the PD 550. If the Polarisation Element 510B is a polarisation splitter then the Upper Circuit 5000A and Lower Circuit 5000B process different polarisations but if the Polarisation Element 510B is a polarisation splitter with polarisation rotator on one of these polarisations then the Upper Circuit 5000A and Lower Circuit 5000B process the same polarisation. For example, Upper Circuit 5000A would process TE as native TE0 and Lower Circuit 5000B would process TM converted into TE0.

Accordingly, optical signals are coupled to the SWORD 500A and initially couple to Polarisation Element 510B which generates a first output U1A having a first polarisation, e.g., Pol(1), and a second output LIA having a second polarisation, e.g., Pol(2). Within an embodiment of the invention Polarisation Element 510B is a polarisation splitter, such as Polarisation Splitter 110 in FIG. 1, such that first output U1A has a TE polarisation and second output LIA a TM polarisation or vice-versa. Within another embodiment of the invention Polarisation Element 510B is a polarisation splitter and rotator, such as Polarisation Splitter and Rotator 210 in FIGS. 2 and 3, such that first output U1A and second output LIA both have a TE polarisation or TM polarisation.

Within the following discussion the description describes Upper Circuit 5000A but it would be evident to one of skill in the art that the Lower Circuit 5000B has a similar structure and functionality with the sole difference being that it is either processing optical signals with a different polarisation when the Polarisation Element 510 is a polarisation splitter or processing optical signals with the same polarisation when the Polarisation Element 510 is a polarisation splitter and polarisation rotator.

Within the Upper Circuit 5000A of SWORD 500A there are depicted first to third Wavelength Selective Optical Switches (first WSOS instances) 520A, 530A and 540A respectively, first and second Points U1B and U1C respectively, and first Selected Wavelength Output U1D 590A. The Lower Circuit 5000B of SWORD 500A comprises fourth to sixth Wavelength Selective Optical Switches (second WSOS instances) 520B, 530B and 540B respectively, third and fourth Points L1B and L1C respectively, and second Selected Wavelength Output L1D 590B.

SWORD 500A by virtue of comprising three stages of WSOS is described below as operating on 8 wavelengths. However, it would be evident to one of skill in the art that the SWORD 500A may employ N stages of WSOS, where N is a positive integer, wherein the SWORD 500A depicted can uniquely select a single channel from M channels where M is given by Equation (1) below.

$$M = {2}^{N} \qquad ( 1 )$$

Accordingly as depicted, the optical signals at first output U1A are coupled to first Wavelength Selective Optical Switch (WSOS) 520A which is designed with a first free spectral range, FSR(1) (e.g. FSR(1)=200 GHz), such that considering an incoming stream of optical signals on 100 GHz spacing at wavelengths L(R) where R=1,2,3, . . . , 7,8 then in a first switch state the first WSOS 520A routes wavelengths L(S) where S=1,3,5,7 . . . to first point U1B. When switched to its second state the first WSOS 520A routes instead wavelengths L(S) where S=2,4,6,8 to first point U1B. Accordingly, the first WSOS 520A may also be referred as an odd-even de-interleaver (D-INT) for Pol(1) whilst second WSOS 520B is a de-interleaver for the same channels for Pol(2) in the context of a polarisation diverse embodiment.

Accordingly, the optical signals propagate forward to second WSOS 530A from first point U1B. Second WSOS 530A has been designed with a second free spectral range, FSR(2) where FSR(2)=2*FSR(1). Hence where FSR(1)=200 GHz then FSR(2)=400 GHz. Second WSOS 530A therefore routes selected wavelengths to second point U1C according to those wavelengths it receives and its switched state.

Table 1 below presents the resulting outputs for second WSOS 530A for its two switched states given the two switched states of the parent WSOS 520A. Accordingly, in each instance a pair of wavelengths are routed to second point U1C.

TABLE 1
Outputs of Second WSOS 530A

| | |
|---|---|
| First WSOS 520A | Second WSOS 530A |

| | Wavelengths at | | Wavelengths at |
|---|---|---|---|
| State | First Point U1B | State | Second Point U1C |
| A | 1, 3, 5, 7 | A | 1, 5 |
| | | B | 3, 7 |
| B | 2, 4, 6, 8 | A | 2, 6 |
| | | B | 4, 8 |

Accordingly, the optical signals propagate forward to third WSOS 540A from second point U1C. Third WSOS 540A has been designed with a third free spectral range, FSR(3) where FSR(3)=2*FSR(2)=4*FSR(1). Hence where FSR(1)=200 GHz then FSR(3)=800 GHz. Third WSOS 540A therefore routes a selected wavelength to Switched Wavelength Output (SWOP) U1D 590A, according to those wavelengths it receives and its switch state.

Table 2 below presents the resulting outputs for third WSOS 540A for its two switch states for each of the different switch state combinations of first WSOS 520A and second WSOS 530A. Accordingly, in each instance, a single selected wavelength of the 8 initial wavelengths received at input of the SWORD 500A are coupled to the SWOP UID 590A.

TABLE 2
Outputs of SWOP U1D 590A

| | | Second WSOS 530A | | Third WSOS 540A | |
|---|---|---|---|---|---|
| First WSOS 520A | | | Wavelengths at | | Wavelength at |
| | Wavelengths at | | Second Point | | SWOP U1D |
| State | First Point U1B | State | U1C | State | 590A |
| A | 1, 3, 5, 7 | A | 1, 5 | A | 1 |
| | | | | B | 5 |
| | | B | 3, 7 | A | 3 |
| | | | | B | 7 |
| B | 2, 4, 6, 8 | A | 2, 6 | A | 2 |
| | | | | B | 6 |
| | | B | 4, 8 | A | 4 |
| | | | | B | 8 |

The SWOP UID 590A is coupled to the high-speed photodetector PD 550 as is the corresponding SWOP LID of the Lower Circuit 5000B where the corresponding WSOS within Lower Circuit 5000B are driven in the same sequence as those in Upper Circuit 5000A. Accordingly, the PD 550 receives two input signals at the same wavelength representing the two polarisations processed by the Upper Circuit 5000A and Lower Circuit 5000B respectively.

Whilst specific inputs/outputs of the first WSOS 520A, second WSOS 530A and third WSOS 540A are depicted in SWORD 500A in FIG. 5A it would be evident that the same input of each subsequent WSOS may be coupled to a different output of the preceding WSOS or that the other input of the subsequent WSOS may be coupled to the different output of the preceding WSOS. Overall, by switching the states of each of the first WSOS 520A, second WSOS 530A and third WSOS 540A a specific wavelength of the 8 input wavelengths is routed to the PD 550. Whilst the specific wavelength at SWOP UID 590A, and the corresponding LID 590B, for each specific state of the first WSOS 520A, second WSOS 530A and third WSOS 540A could be different, the different states still allow each of the 8 wavelengths to be selected and coupled to the PD 550.

Accordingly, the SWORD 500A switches between different wavelengths based upon state changes of one or more of the first WSOS 520A, second WSOS 530A and third WSOS 540A. As will be evident from WSOS schematic 500B in FIG. 5A as described below within embodiments of the invention each of the WSOS is controlled via a single control signal and aligned to the wavelength grid with a single bias signal.

It would be evident that, within an alternate embodiment of the invention, the FSR sequence of the first WSOS 520A, second WSOS 530A and third WSOS 540A may be reversed such that third WSOS 540A has the smallest FSR, e.g., 800 GHz, 400 GHz, 200 GHz, etc. as appropriate given the 100 GHz channel spacing being used as an appropriate example. Accordingly, with third WSOS 540A having FSR(3) then second WSOS 530A has FSR(2)=2*FSR(3) and first WSOS 520A has FSR(1)=2*FSR(2)=4*FSR(3). Hence, if FSR(3)=200 GHz then FSR(2) is 400 GHz and FSR(1) is 800 GHz whilst this yields a different frequency sequence for the different switch states of first WSOS 520A, second WSOS 530A and third WSOS 540A.

As depicted the Upper Circuit 5000A is controlled via three control signals U1, U2 and U3 respectively whilst Lower Circuit 5000B is controlled via three control signals L1, L2 and L3, respectively. Within the claims for sake of clarity and case of differentiating WSOS elements within the Upper Circuit 5000A and Lower Circuit 5000B the WSOS elements in one circuit, e.g., Upper Circuit 5000A or Lower Circuit 5000B, are referred to as “first WSOS elements” whilst the WSOS elements in the other of the Upper Circuit 500)A and Lower Circuit 5000B are referred to a “second WSOS elements.”

Within FIG. 5A the embodiment of a WSOS element according to an embodiment of the invention, WSOS 500B, exploiting an unbalanced Mach-Zehnder interferometer is depicted although other elements may be employed without departing from the scope of the invention. As depicted the WSOS 500B has first and second inputs 5010 and 5020 respectively, a first 3 dB coupler 5030, Switch Element 5040, Bias Element 5050, second 3 dB coupler 5060 and first and second outputs 5070 and 5080, respectively. An optical path imbalance between the first 3 dB coupler 5030 and second 3 dB coupler 5060 is implemented between Switch Element 5040 and Bias Element 5050 which provides the appropriate free spectral range of the WSOS, e.g. FSR(1) for first WSOS 520A, FSR(2) for second WSOS 530A and FSR(3) for third WSOS 540A in SWORD 500A. Accordingly, each WSOS provides a periodic frequency response. Bias Element 5050 provides for biassing the WSOS to compensate for fabrication variations. Switch Element 5040 provides control of the WSOS such that the frequencies output to first output 5070 and second output 5080 are established for each switch state. Hence, considering WSOS 500B and first WSOS 520B then Switch Element 5040 provides for setting the WSOS into either of the two switch states such that in the first switch state the WSOS routes wavelengths L(S) where S=1,3,5,7 to first Output 5070 and wavelengths L(T) where T=2,4,6,8 to second Output 5080. In the second switch state the WSOS routes wavelengths L(S) where S=1,3,5,7 to second Output 5080 and wavelengths L(T) where T=2,4,6,8 to the first Output 5070. Accordingly, each WSOS within the SWORD is controlled via a single control to the Switch Element 5040 in push mode, or with two controls to both switch elements 5040 and 5050 in a push-pull mode of operation.

It is noted that in the case where output coupler 5060 is a 2×2 coupler, which is an alternate design of WSOS 500B rather than a 2×1 coupler, the cascading of WSOS may allow sharing the output 2×2 5060 of a parent WSOS with the input 2×2 5030 of a child WSOS in a tree of WSOS. It would be evident to one skilled in the art that input couplers 5030 and output couplers 5060 may be implemented as a 1×2 Y-branch, 1×2 or 2×2 directional couplers, 1×2 or 2×2 bent directional couplers, 1×2 or 2×2 rapid adiabatic couplers, 1×2 multi-mode interferometers (MMIs) or 2×2 multi-mode interferometers (MMIs).

In the context of a WSOS with its embedded optical switching, it is now possible to reduce the SWORD to a single instance of a cascade of WSOS with a corresponding progressive doubling or halving of the free spectral range. Accordingly, with a single tree of cascaded deinterleavers, the use of a 1×2 for the 5030 input coupler would be sufficient, unless a deliberate use of the second input provided by a 2×2 coupler 5030 would be made for the purpose of circuit calibration, monitoring, or configuration, such as described below in respect of SWORD 500C in FIG. 5B. The 1×2 or 2×2 MMIs may be angled, so as to output a coupling coefficient which may deliberately not be 50/50, making it possible for the deinterleaving function of a WSOS to have a box-like spectral response by cascading two or more Mach-Zehnder Interferometers (MZIs) with different coupling ratios, within a single instance of a WSOS. It is known in the state of the art that a power coupling coefficient of 29% between a first and the second Mach-Zehnder Interferometer within a WSOS and a power coupling coefficient of 8% in its final output 2×2 would provide a 3^{rd} order Butterworth response. It is also even possible to cascade a third MZI within a WSOS to obtain a 5^{th} order Butterworth response with a power coupling coefficient of 85.2% between the 1^{st} and 2^{nd} MZI, a coupling coefficient of 24.8% between the 2^{nd} and 3^{rd} MZI and a coupling coefficient of 1.5% in the final output 2×2 coupler (or 2×2 MMI).

It would also be possible to introduce additional MZIs within a WSOS with additional thermal tuners, for the purpose of being able to control them separately to ensure the performance of the main MZIs, see for example D. A. B. Miller, “Perfect Optics with Imperfect Components” (Optica 2, 747-750 (2015)) in order to improve the extinction ratio of balanced MZIs and the wavelength extinction ratio of unbalanced MZIs used inside the WSOS. Finally, each WSOS could also be configured with MMIs with even more input and output ports, allowing stacking of WSOS rather than their daisy chaining.

It would be evident that whilst an unbalanced MZI is described and depicted with respect to embodiments of the invention that these may be replaced and/or augmented with other optical components. For example, the MZI may be replaced with a Michelson interferometer, a Gires-Tournois interferometer, Fabry-Perot structures, Fibonacci quasi-periodic gratings, ring resonators. Further, the unbalanced MZI or a balanced MZI can be augmented with ring resonators to establish a resonator assisted MZI (RA-MZI). With a RA-MZI more complex filter functions can be generated, such as for example, a 3^{rd} order Butterworth box-like response. Such a RA-MZI may be employed to provide a box-like filter function response to any WSOS stage, without need for cascading MZIs within any WSOS stage, wherein the MZI of the RA-MZI would be further augmented to include an optical switching function, within a SWORD according to an embodiment of the invention.

Now referring to SWORD 500C in FIG. 5B there is depicted an exemplary switched wavelength optical receiver for direct-detection (SWORD) employing a cascade of wavelength selective optical switches (WSOS) which have their second input port connected to an additional optical switch and monitoring photodetector to provide feedback for circuit calibration, monitoring, and configuration. A Polarisation Component 510 generates signals to U1A with a first polarisation, Pol(1), which are coupled to the Upper Circuit 5000C and other signals to LIA with a second polarisation, Pol(2), which are coupled to the Lower Circuit 5000D.

Within the Upper Circuit 5000C of SWORD 500C there are depicted first to third Wavelength Selective Optical Switches (WSOS instances) 520C, 530C, and 540C respectively, first and second Points U1B and U1C respectively, Selected Wavelength Output (SWOP) U1D 590A, first Test Point U2A 570A, second Test Point U2B 575A, third Test Point U2C, first Test Output U3A 585A, second Test Output U3B 585B, third Test Output U3C 585C, fourth Test Output U3D 585D, fifth Test Output U3E 585E and sixth Test Output U3F 585F.

As depicted in SWORD 500C in FIG. 5B, the first output U1A is coupled to Upper Circuit 5000C whilst second output LIA is coupled to Lower Circuit 5000D. The outputs from the Upper Circuit 5000C and Lower Circuit 5000D being coupled to PD 550 and to Monitor PD 565 via Optical Switch 560.

Accordingly, as depicted the optical signals at first output UIA are coupled to first Wavelength Selective Optical Switch (WSOS) 520C which is designed with a first free spectral range, FSR(1) (e.g. FSR(1)=200 GHz), such that considering an incoming stream of optical signals on 100 GHz spacing at wavelengths L(R) where R=1,2,3, . . . , 7,8 then in a first switch state the first WSOS 520C routes wavelengths L(S) where S=1,3,5,7 to first point U1B and wavelengths L(T) where T=2,4,6,8 to sixth Test Output U3F 585F. When switched to its second state the first WSOS 520C routes instead wavelengths L(S) where S=1,3,5,7 to sixth Test Output U3F 585F and wavelengths L(T) where T=2,4,6,8 to first point U1B 585F.

Accordingly, the optical signals including the channel to be finally selected propagate forward to second WSOS 530C from first point U1B. Second WSOS 530C therefore routes selected wavelengths to second point U1C and fifth Test Output U3E 585E according to those wavelengths it receives and its switch state.

Accordingly, the optical signals including the channel to be finally selected propagate forward to third WSOS 540C from second point U1C. Third WSOS 540C therefore routes the selected channel to SWOP U1D 590A and the other remaining optical signal present at the final stage to fourth Test Output U3D 585D according to those wavelengths it receives and its switch state.

Also depicted within Upper Circuit 5000C is first Test Point U2A 570A which is coupled to first Test Output U3A 585A from the other input of first WSOS 520C. First Test Point U2A 570A may be an optical switch allowing optical signals coupled to it to be routed to the first Test Output U3A 585A from the other input of first WSOS 520C or a passive coupler allowing optical signals coupled to it to be routed to the first Test Output U3A 585A from the other input of first WSOS 520C concurrently. First Test Point U2A 570A therefore allows for circuit calibration, monitoring, and configuration of SWORD 500C.

Similarly, within Upper Circuit 5000C is second Test Point U2B 575A which is coupled to second Test Output U3B 585B from the other input of second WSOS 530C. Second Test Point U2B 575A may be an optical switch allowing optical signals coupled to it to be routed to the second Test Point U3B 585B from the other input of second WSOS 530C or a passive coupler allowing optical signals coupled to it to be routed to the second Test Output U3B 585B from the other input of second WSOS 530C concurrently. Second Test Point U2B 575A therefore allows for circuit calibration, monitoring, and configuration of SWORD 500C.

Similarly, within Upper Circuit 5000C is third Test Point U2C 580A which is coupled to third Test Output U3C 585C from the other input of third WSOS 540C. Third Test Point U2C 580A may be an optical switch allowing optical signals coupled to it to be routed to the third Test Point U3C 585C from the other input of third WSOS 540C or a passive coupler allowing optical signals coupled to it to be routed to the third Test Output U3C 585C from the other input of third WSOS 540C concurrently. Third Test Point U2C 580A therefore allows for circuit calibration, monitoring, and configuration of SWORD 500C.

As depicted SWORD 500C also comprises the Lower Circuit 5000D of similar design as the Upper Circuit 5000C but coupled to LIA which receives optical signals with Pol(2) from the Polarisation Component 510 whilst Upper Circuit 5000C receives optical signals with Pol(1) from the Polarisation Component 510.

If Polarisation Component 510 is a polarisation splitter, such as Polarisation Management Splitter 110 in FIG. 1, then Pol(1) may be transverse electric (TE) and Pol(2) transverse magnetic (TM) or vice-versa. However, if Polarisation Component 510 is a polarisation splitter with a polarisation rotator, such as Polarisation Splitter and Rotator 210 in FIG. 2, then Pol(1) may be transverse electric (TE) or transverse magnetic (TM) and Pol(2) is the same.

The outputs from first Test Output U3A 585A, second Test Output U3B 585B, third Test Output U3C 585C, fourth Test Output U3D 585D, fifth Test Output U3E 585E, and sixth Test Output U3F 585F are depicted as being routed to Optical Switch 560 as are their corresponding outputs in the Lower Circuit 5000D, namely L3A, L3B, L3C, L3D, L3E and L3F. The Optical Switch 560 being depicted as having a single output port which is coupled to Monitor PD 565. Alternatively Optical Switch 560 may be a pair of optical switches each associated with one of the Upper Circuit 5000C and Lower Circuit 5000D such that these provide the corresponding outputs from each of these to the Monitor PD 565 or to a pair of Monitor PDs 565. In this manner, first Test Output U3A 585A, second Test Output U3B 585B, third Test Output U3C 585C, fourth Test Output U3D 585D, fifth Test Output U3E 585E, and sixth Test Output U3F 585F and their corresponding outputs in the Lower Circuit 5000D, namely L3A, L3B, L3C, L3D, L3E and L3F can be used to provide optical feedback for calibration, monitoring and configuration of the SWORD 500C such as during an initial die level characterisation prior to packaging, after packaging or as feedback to a control circuit associated with the dynamic selection of wavelength channels during the lifetime operation of SWORD 500C.

Optionally, the first Test Point U2A 570A, second Test Point U2B 575A and third Test Point U2C 580A may only couple to their respective WSOS such that the optical paths to the first Test Output 585A, second Test Output 585B and third Test Output 585C are not implemented. Similarly, the corresponding structures within the Lower Circuit 5000D may be omitted.

Accordingly, it would be evident that optical testing of the SWORD 500C can be implemented for the third WSOS 540C discretely via third Test Point U2C 580A and fourth Test Output 585D. Second WSOS 530C can be discretely optically tested via second Test Point U2B 575A and fifth Test Output 585E. First WSOS 520C can be optically tested discretely via first Test Point U2A 570A and sixth Test Output 585F. Optionally, the Optical Switch 560 and Monitor PD 565 may be hybrid integrated with the PIC, monolithically integrated within the PIC or external to the PIC. Similarly, high-speed PD 550 may be hybrid integrated with the PIC, monolithically integrated within the PIC or external to the PIC.

Up to this point, the exemplary scenarios described and depicted in FIGS. 5A and 5B, as well as FIGS. 1-3, have been for an 8-channel SWORD making use of a cascaded sequence of 3 WSOS. However, it would be evident that it would be possible to implement a 16-channel SWORD with a cascade of four WSOS, a 32-channel SWORD with a cascade of 5 WSOS, etc. The greater the number of WSOS in the tree, the more complex the control will be and so will the challenge of routing all of the other inputs of the input 2×2 couplers and/or other outputs of the output 2×2 couplers of the WSOS to separate monitoring photodetector(s). While it may be possible to route all of them to a single photodetector in the manner described to let the signals integrate into free space onto the facet of the photodetector, it would not be possible to distinguish feedback coming from the 1^{st} stage WSOS versus that of the Nth stage. Here the inventors have pioneered the integration of an additional N×1 optical switch (or multiple instances of smaller radix N×1 optical switches cascaded), allowing to sequentially analyze the optical signals which are not coupled to the output ports of a WSOS stage within a tree of WSOS instances in a SWORD. The N×1 switch(es) is used to tap the second input of some or each of the WSOS and the optical feedback is used to implement the calibration, monitoring, and configuration of the SWORD.

Control of the WSOS instances in a SWORD may be accomplished through monitoring receiver signal strength indicator (RSSI) of a transimpedance amplifier (not illustrated) connected to the high-speed photodetector PD 550 while running the calibration, monitoring, or control sequences of the SWORD. Embodiments of the invention support additional monitoring, for example by an N×1 switch such as Optical Switch 560 coupled to PD 565 or by multiple PDs 565 each connected to one or more input/output ports of the WSOS instances in a SWORD.

Similar to Upper Circuit 5000A in FIG. 5A the Upper Circuit 5000C in FIG. 5B can be controlled via three control signals U1, U2 and U3, respectively. Similarly, Lower Circuit 5000D may be controlled via three control signals L1, L2 and L3 respectively as depicted with Lower Circuit 5000B in FIG. 5A. Each control signal may include one or more sub-controls in the context of push-pull implementation.

Whilst FIGS. 1 to 4 have described embodiments of a SWORD relying on cascade of deinterleavers optimally designed such as to minimize the number of components with the smallest FSR, the WSOS described in FIG. 5A no longer relies on a discrete separate trec of de-interleavers given the integrated optical switching function within the WSOS and, accordingly, it would be evident to one skilled in the art, that the order in which the WSOS are setup could be starting with the largest FSR to end with the smallest FSR, as there is now only one instance of a WSOS for every doubling (or halving) of the FSR at each stage of a cascade of WSOS 5000A and 5000B within a SWORD 500A. It would further be evident to one skilled in the art that the order may be from the largest FSR to the smallest FSR in WSOS cascade 5000A while being from the smallest FSR to the largest FSR in WSOS cascade 5000B yet permitting to select and route the Pol(1) component and the Pol(2) component of the same channel to PD 550.

Within another embodiment of the invention, it would also be possible to set-up the cascade of WSOS within Upper Circuit 5000A and Lower Circuit 5000B within the 8-channel SWORD 500A as depicted in FIG. 5A according to a different sequence of WSOS elements. Considering, a channel spacing of 100 GHZ, then it is necessary to have at least one WSOS with an FSR of 200 GHz, at least one another WSOS with an FSR of 400 GHz and at least one further WSOS with an FSR of 800 GHz. However, the WSOS do not need to be in the order 200 GHZ, 400 GHz and 800 GHz as described elsewhere within this specification or the reverse sequence of 800 GHz, 400 GHz, and 200 GHz. Rather, it is merely a requirement for them all to be employed. Accordingly, different orders can be employed without any need for WSOS to be into any sequential order.

Accordingly, it would be possible to generalize the SWORD to select among N channels to have;
i) Log2(N) number of WSOS stages in either a single cascade (polarisation independent WSOS stages) or within each cascade (polarisation dependent WSOS stages, wherein, the first WSOS stage, has an FSR that is twice that of the channel spacing, and;
ii) Log2(N)-1 other WSOS stages following a series I=2,3,4,5,6,7,8,9, etc, with a distinct FSR corresponding to the channel spacing multiplied by 2\hat{ }I, and;
iii) with no need for the WSOS stages to be into any prescribed sequential order within the cascade or cascades.

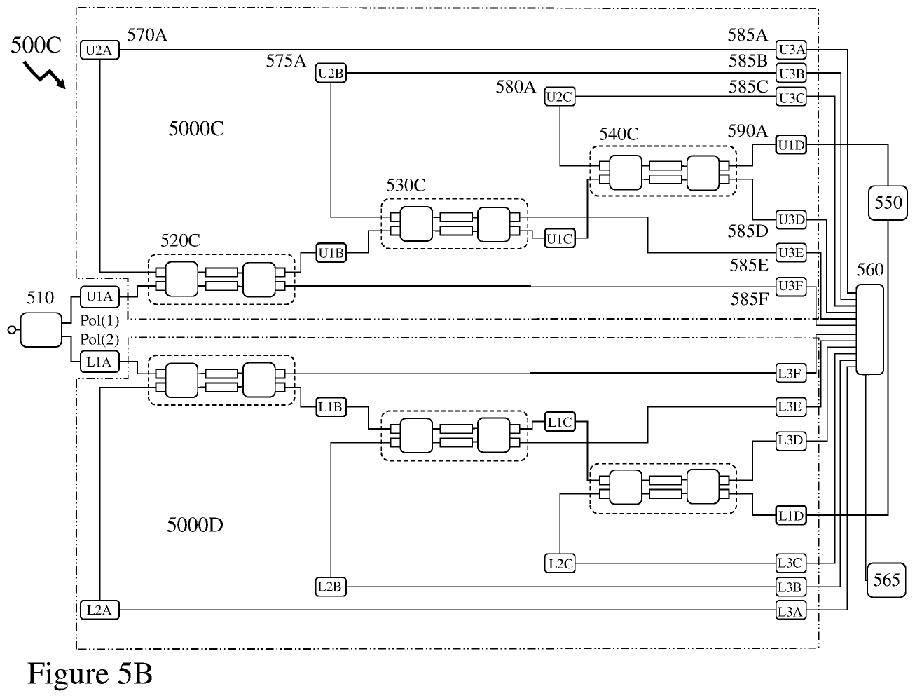

Referring to FIG. 6 there is depicted an exemplary Flow 600 for controlling a WSOS under different fabrication tolerance scenarios. The scenarios being with respect to what the inventors refer to as the WSOS being designed to operate in a “cross” switch state, e.g. if the WSOS has a 200 GHz FSR and receives channels L(1) to L(8) on a 100 GHz channel spacing then the “cross” state routes wavelengths L(S) where S=1,3,5,7 to the next stage and therefore when the WSOS is set into the “bar” state the other wavelengths L(T) where T=2,4,6,8 are coupled to the next stage.

Accordingly, three possible scenarios are depicted as defined within Scenario Setting 6110. It would be evident that these are exemplary embodiments to present the logic flow for controlling each WSOS within a SWORD and hence the SWORD overall. These comprising:
Scenario A 610A wherein the fabrication is perfect;
Scenario B 610B wherein the fabrication results in an effective red shift of the WSOS wavelength response of 10% of the FSR (e.g., Red Shift=0.1*FSR, i.e., 20 GHz for FSR=200 GHz or 160 GHz for FSR=1,600 GHZ)
Scenario C 610C wherein the fabrication results in an effective blue shift of the WSOS wavelength response of 10% of the FSR (e.g., Blue Shift=0.1*FSR, i.e., 20 GHz for FSR=200 GHz or 160 GHz for FSR=1,600 GHz).

There could be more scenarios given possible fabrication imperfection greater than 10% of the intended FSR to be fabricated.

Accordingly, for each case a decision is established by the controller controlling the WSOS as to whether the WSOS should be in the “cross” state or “bar” state. Accordingly, for Scenario A 610A the Decision 615A leads the Flow 600 to Upper Block 6120 for the “cross” state and Lower Block 6130 for the “bar” state. Similarly, Decision B 615B is established in the instance of Scenario B 610B and Decision C 615C is established in the instance of Scenario C 610C.

Considering Scenario A 610A then if Decision A 615A is for the WSOS to be in the “cross” state as the fabrication was perfect then no additional phase shifting is required and the Flow 600 proceeds to first Cross Additional Phase Shifter 620A, which is no additional phase shifting so no power is consumed by the thermo-optic phase shifter elements within the WSOS. If Decision A 615 is for the WSOS to be set into the “bar” state then the controller establishes a shift of 0.5 FSR, for example a red shift of 0.5 FSR, as defined by first Bar Additional Phase Shifter 625A wherein if the WSOS employs a standard heater structure. Flow 600 proceeds to first Standard Bar Setting 650A but if the WSOS employs what the inventors refer to as an enhanced heater structure Flow 600 proceeds to first Enhanced Bar Setting 660A. For example, a standard heater structure within a WSOS may require 20 mW to shift frequency response by 1 FSR whereas an enhanced heater structure may require 15 mW. Accordingly, the 0.5 FSR shift in first Standard Bar Setting 650A corresponds to an applied power of 10 mW and in first Enhanced Bar Setting 660A an applied power of 7.5 mW. From first Cross Additional Phase Shifter 620A the Flow 600 proceeds therefore to Cross State 670 such that the WSOS is in the “cross” state whereas from first Bar Additional Phase Shifter 625A the Flow 600 proceeds to Bar State 680 such that the WSOS is in the “bar” state.

Now considering Scenario B 610B then if Decision B 615B is for the WSOS to be in the “cross” state then as the fabrication was red shifted by 0.1 FSR then additional phase shifting to the “cross” state is required and the Flow 600 proceeds to second Cross Additional Phase Shifter 620B wherein the controller must establish a red shift of 0.9 FSR. If the WSOS employs a standard heater structure Flow 600 proceeds to first Standard Cross Setting 630B but if the WSOS employs an enhanced heater structure Flow 600 proceeds to first Enhanced Cross Setting 640B. In this exemplary scenario the respective powers for 0.9FSR being 18 mW and 13.5 mW for first Standard Cross Setting 630B and first Enhanced Cross Setting 640B, respectively. Flow 600 then proceeds against to Cross State 670. If Decision B 615B is for the WSOS to be set into the “bar” state then the controller must establish a red shift of 0.5 FSR on top of the offset 0.1 FSR to establish the “bar” as defined by second Bar Additional Phase Shifter 625B wherein if the WSOS employs a standard heater structure Flow 600 proceeds to second Standard Bar Setting 650B but if the WSOS employs what the inventors refer to as an enhanced heater structure Flow 600 proceeds to second Enhanced Bar Setting 660B. In this exemplary scenario the respective powers for 0.6 FSR being 12 mW and 9 mW. From second Bar Additional Phase Shifter 625B the Flow 600 proceeds to Bar State 680 such that the WSOS is in the “bar” state.

Now considering Scenario C 610C then if Decision C 615C is for the WSOS to be in the “cross” state then as the fabrication was blue shifted by 0.1 FSR then additional phase shifting to the “cross” state is required and the Flow 600 proceeds to third Cross Additional Phase Shifter 620C wherein the controller must establish a red shift of 0.1 FSR. If the WSOS employs a standard heater structure Flow 600 proceeds to second Standard Cross Setting 630B but if the WSOS employs an enhanced heater structure Flow 600 proceeds to second Enhanced Cross Setting 640B. In this exemplary scenario the respective powers for 0.1FSR being 2 mW and 1.5 mW, respectively. Flow 600 then proceeds again to Cross State 670. If Decision C 615C is for the WSOS to be set into the “bar” state then the controller must establish a red shift of 0.4 FSR to establish the “bar” as defined by third Bar Additional Phase Shifter 625C wherein if the WSOS employs a standard heater structure Flow 600 proceeds to third Standard Bar Setting 650C but if the WSOS employs what the inventors refer to as an enhanced heater structure Flow 600 proceeds to third Enhanced Bar Setting 660C. In this exemplary scenario the respective powers for 0.4FSR being 8 mW and 6 mW, respectively. From third Bar Additional Phase Shifter 625C the Flow 600 proceeds to Bar State 680 such that the WSOS is in the “bar” state.

The amount of blue shift or red shift compensation of fabrication imperfection stated earlier and associated levels of power consumption of the phase shifters in milliwatts (mW) span an infinite range of possibilities and the values provided in the description of the invention are just one possibility presented by way of an example.

It would be evident that the red or blue shift of a WSOS may be established during optical characterisation of the WSOS and stored within a memory associated with the controller such that the controller can execute the appropriate heater settings to establish the “cross” and “bar” states of the WSOS to route either a first subset of the incoming optical signals forward to a subsequent WSOS stage or photodiode or a second subset of the incoming optical signals, offset relative to the first subset by 0.5 FSR.

It is well known to one skilled in the art, that the fabrication tolerances of integrated optics polarisation management devices in high-index contrast platforms such as silicon photonics and silicon nitride photonics, results in some level of polarisation crosstalk. Such polarisation crosstalk means that a residual portion of Pol(1) is mixed on the Pol(2) output port of the polarisation management device, and vice-versa, that is a portion of Pol(2) is mixed with Pol(1) on the first output port of the polarisation management device. Accordingly any reference to Transverse Electric (TE) signals implies that any reference to TE is in fact, Quasi-TE, that is Transverse Electric components with some level of Transverse Magnetic (TM) components is present on the TE output port of a polarisation splitter, and vice versa, that is any reference to TM means Quasi-TM, that is some level of TE components is present in the TM signal output port, of a polarisation splitter. In the case of a polarisation splitter-rotator, typically implemented through mode evolution, the first output port outputs the TE0 mode as TE while and the 2^{nd} output port, outputs some level of the TE0 mode of the first output port into the 2^{nd} output port, which is inherently not in phase with the Quasi-TM component of the signal converted to TE1 and then TE. Accordingly, an unbalanced Mach-Zehnder Interferometer processing a Pol(1) signal with some residual level of Pol(2) will necessarily generate some level of polarization dependent wavelength shift for that portion of Pol(2) that is not inherently in phase with Pol(1), giving rise to an increase of the inter-channel crosstalk. The same would apply for the other cascade of D-INTs or WSOS processing the Pol(2) stream with some residual level of Pol(1). Accordingly, the authors have identified that improved performance of the SWORD would be made possible by cascading polarisation diversity elements (polarisation splitters or polarisation splitter rotators) on the input of the two deinterleaver cascades within the SWORD or the cascade of WSOS within the SWORD, such as to increase the extinction of the residual level of Pol(2) into Pol(1) and vice-versa.

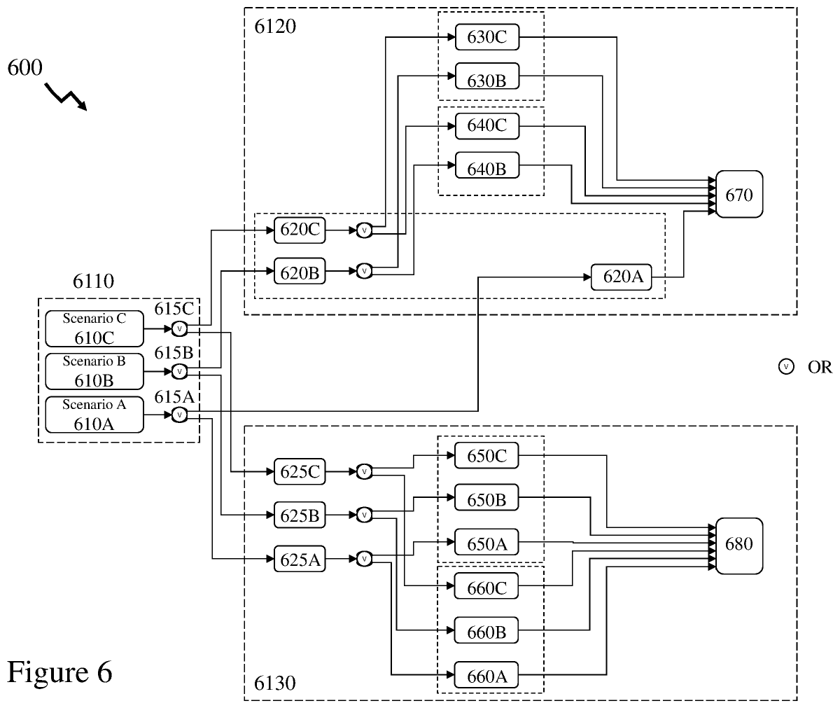

FIG. 7 depicts a polarisation diverse switched wavelength optical receiver (SWORD) 700 exploiting WSOS based Mach-Zehnder deinterleavers with integrated optical switching according to an embodiment of the invention. As depicted the SWORD 700 comprises a Polarisation Element 710 generating an upper stream with a first polarisation Pol(1) and a lower stream with second polarisation Pol(2). The upper stream is then passed by second Polarisation Element 720A whilst the lower stream is passed by third Polarisation Element 720B. The upper Pol(1) stream is processed by first to N upper WSOS instances 730(1) to 730(N) respectively before being coupled to PD 750 whilst the lower Pol(2) stream is processed by first to N lower WSOS instances 740(1) to 740(N) respectively before being coupled to PD 750. As discussed above first Polarisation Element 710 may generate Pol(1)≠Pol(2) or it may generate Pol(1)=Pol(2). In either instance the second and third Polarisation Elements 720A and 720B are designed to improve the polarisation extinction ratio in their respective stream. Within an embodiment of the invention each WSOS of the first to N upper WSOS instances 730(1) to 730(N) respectively and first to N lower WSOS instances 740(1) to 740(N) respectively may be a cascade of Mach-Zehnder deinterleavers element combined with an optical switch such as described and depicted in respect of FIGS. 5A and 5B, respectively. Polarisation Element 720A may be either a polarisation splitter or a polarisation splitter rotator.

However, in either the cascade of Mach-Zehnder deinterleavers and/or a PIC switch, polarisation crosstalk can be induced due to random variations in the widths of the optical waveguides due to manufacturing imperfections. Accordingly, within each WSOS, where additional polarisation crosstalk may be induced, a wavelength dependent crosstalk may result due to PIC implementations where the refractive indices and phase shifts of the TE and TM polarisations are different, each WSOS instances will exhibit a different FSR for the TE and TM polarisations, together with red/blue shifts from desired design point. Accordingly, unless additional polarisation filtering is added at the entrance or exit of a cascade of WSOS for a given polarization, then increased wavelength dependent crosstalk will be observed from the polarisation crosstalk.

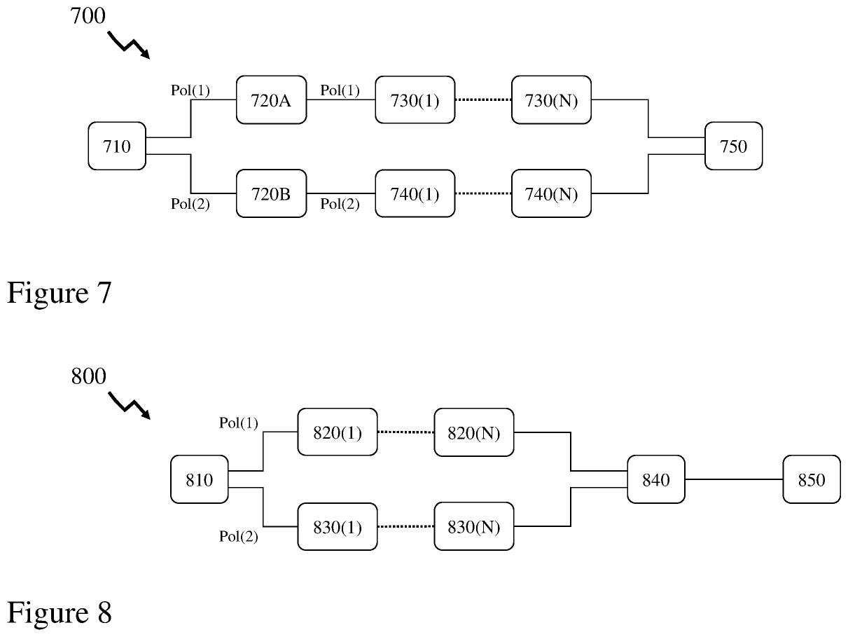

Now referring to FIG. 8 there is depicted a polarisation diverse SWORD 800 exploiting WSOS based Mach-Zehnder deinterleavers with integrated optical switching according to an embodiment of the invention. As depicted the SWORD 800 comprises a Polarisation Element 810 generating an upper stream with a first polarisation Pol(1) and a lower stream with second polarisation Pol(2). The upper Pol(1) stream is processed by first to N upper WSOS instances 820(1) to 820(N) respectively before being coupled to Polarisation Combiner 840 and therein to PD 850 whilst the lower Pol(2) stream is processed by first to N lower WSOS instances 830(1) to 830(N) respectively before being coupled to Polarisation Combiner 840 and therein to PD 850. As discussed above first Polarisation Element 810 may generate Pol(1)≠Pol(2) or it may generate Pol(1)=Pol(2). The Polarisation Combiner provides a means of reducing the polarization dependent inter-channel crosstalk arising within the multiple WSOS instances from the non-perfect vertical sidewalls of the channel waveguides within the PIC comprising the WSOS instances. The use of the polarisation combiner 840 also makes it possible to reduce the number of waveguides facing the PD 850 down to a single waveguide, which helps improving coupling efficiency to the PD 850 as well as simplifying the coupling to PD 850. Polarisation Elements 810 and 840 may be either matched polarisation splitters & polarisation combiners or matched polarisation splitter rotators & polarisation rotator combiners.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skilled in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A switched wavelength optical receiver comprising:
a plurality of wavelength selective optical switch (WSOS) elements coupled in series wherein the first WSOS element of the plurality of WSOS elements is coupled to a first output of a polarization management element and each sequential WSOS element of the plurality of WSOS elements has a free spectral range (FSR) equal to the FSR of the preceding WSOS of the plurality of WSOS elements multiplied by a first constant; and
a photodetector coupled to the output of the last WSOS of the plurality of WSOS elements; wherein
each WSOS element of the plurality of WSOS elements is dynamically configurable between a first state and a second state such that the plurality of WSOS elements filter an incoming optical stream of a plurality optical signals having a predetermined channel spacing;
in the first state each WSOS element of the plurality of WSOS elements passes a first subset of those wavelengths coupled to it; and
in the second state each WSOS element of the plurality of WSOS elements passes a second subset of those wavelengths coupled to it.

2. The switched wavelength optical receiver according to claim 1, wherein one of:
the first constant is either 0.5 or 2.0;
the predetermined channel spacing is half that of the smallest FSR of the plurality of WSOS elements and the first state and the second state within each WSOS element of the plurality of WSOS elements are offset by a predetermined portion of the FSR of that WSOS element of the plurality of WSOS elements; and
the first constant is either 0.5 or 2.0 and the predetermined portion is 50%.

3-4. (canceled)

5. The switched wavelength optical receiver according to claim 1, wherein one of:
each WSOS element of the plurality of WSOS elements comprises an optical de-interleaver (D-INT) having a pair of outputs and a waveguide based optical switch (OS) coupled to the pair of outputs of the D-INT;
each WSOS element of the plurality of WSOS elements comprises an optical de-interleaver (D-INT) having a pair of outputs and a microelectromechanical systems (MEMS) based optical switch (OS) coupled to the pair of outputs of the D-INT;
each WSOS element of the plurality of WSOS elements comprises a Mach-Zehnder interferometer (MZI) based optical de-interleaver (D-INT) and a MZI based optical switch (OS); and
each WSOS element of the plurality of WSOS elements comprises a Mach-Zehnder interferometer (MZI) based optical de-interleaver (D-INT) and a microelectromechanical systems (MEMS) based optical switch (OS);
in the first state the OS selects an output of the pair of outputs of the D-INT; and
in the second state the OS selects the other output of the pair of outputs of the D-INT.

6-8. (canceled)

9. The switched wavelength optical receiver according to claim 1, wherein
each WSOS element of a first subset of the plurality of WSOS elements comprises a Mach-Zehnder interferometer (MZI) based optical de-interleaver (D-INT) and a MZI based optical switch (OS);
each WSOS element of a second subset of the plurality of WSOS elements comprises a Mach-Zehnder interferometer (MZI) based optical de-interleaver (D-INT) and a microelectromechanical systems (MEMS) based optical switch (OS);
in the first state of each WSOS of the plurality of WSOS elements the OS selects an output of the pair of outputs of the D-INT; and
in the second state the OS selects the other output of the pair of outputs of the D-INT.

10. A switched wavelength optical receiver comprising:
a polarisation element for generating a first output with a first polarisation and a second output with a second polarisation;
a plurality of first wavelength selective optical switch (WSOS) elements coupled in series wherein the first WSOS element of the plurality of first WSOS elements is coupled to the first output of the polarization element and each sequential first WSOS element in the plurality of first WSOS elements has a free spectral range (FSR) equal to the FSR of the preceding first WSOS element of the plurality of first WSOS elements multiplied by a constant; and
a plurality of second wavelength selective optical switch (WSOS) elements coupled in series wherein the first second WSOS element of the plurality of second WSOS elements is coupled to the second output and each sequential second WSOS element in the plurality of second WSOS elements has an FSR equal to the FSR of a preceding second WSOS element of the plurality of second WSOS elements multiplied by the constant; wherein
an output of the last first WSOS of the plurality of first WSOS elements is coupled to a photodetector; and
an output of the last second WSOS of the plurality of second WSOS elements is coupled to the photodetector.

11. The switched wavelength optical receiver according to claim 10, wherein one of:
the constant is either 0.5 or 2.0;
the switch wavelength optical receiver selects a predetermined optical signal from an incoming optical stream of a plurality optical signals having a predetermined channel spacing where the predetermined channel spacing is half that of the smallest FSR of the plurality of WOS elements and the first state and the second state within each first WSOS element of the plurality of first WSOS elements and each second WSOS element of the plurality of second WSOS elements are offset by a predetermined portion of the FSR of that first WSOS element of the plurality of first WSOS elements or second WSOS element of the plurality of second WSOS elements; and
the constant is either 0.5 or 2.0 and the predetermined portion is 50%.

12-13. (canceled)

14. The switched wavelength optical receiver according to claim 10, wherein
one of:
each first WSOS element of the plurality of first WSOS elements and each second WSOS element of the plurality of second WSOS elements comprises an optical de-interleaver (D-INT) having a pair of outputs and a waveguide based optical switch (OS) coupled to the pair of outputs of the D-INT;
each first WSOS element of the plurality of first WSOS elements and each second WSOS element of the plurality of second WSOS elements comprises an optical de-interleaver (D-INT) having a pair of outputs and a microelectromechanical systems (MEMS) based optical switch (OS) coupled to the pair of outputs of the D-INT;
each first WSOS element of the plurality of first WSOS elements and each second WSOS element of the plurality of second WSOS elements comprises a Mach-Zehnder interferometer (MZI) based optical de-interleaver (D-INT) and a MZI based optical switch (OS);
each first WSOS element of the plurality of first WSOS elements and each second WSOS element of the plurality of second WSOS elements comprises a Mach-Zehnder interferometer (MZI)) based optical de-interleaver (D-INT) and a microelectromechanical systems (MEMS) based optical switch (OS);
in the first state each OS selects an output of the pair of outputs of its associated D-INT; and
in the second state each OS selects the other output of the pair of outputs of its associated D-INT.

15-17. (canceled)

18. The switched wavelength optical receiver according to claim 10, wherein
each WSOS element of a first subset of the plurality of WSOS elements comprises a Mach-Zehnder interferometer (MZI) based optical de-interleaver (D-INT) and a MZI based optical switch (OS);
each WSOS element of a second subset of the plurality of WSOS elements comprises a Mach-Zehnder interferometer (MZI) based optical de-interleaver (D-INT) and a microelectromechanical systems (MEMS) based optical switch (OS);
in the first state of each WSOS of the plurality of WSOS elements the OS selects an output of the pair of outputs of the D-INT; and
in the second state the OS selects the other output of the pair of outputs of the D-INT.

19. The switched wavelength optical receiver according to claim 10, wherein
one of:
the first polarisation is orthogonal to the second polarisation;
the first polarisation is the same as the second polarisation;
each first WSOS element of the plurality of first WSOS elements is configured between a first state and a second state offset by fifty percent of the FSR of that first WSOS of the plurality of first WSOS elements by a single control;
each second WSOS element of the plurality of second WSOS elements is configured between a first state and a second state offset by fifty percent of the FSR of that second WSOS of the plurality of second WSOS elements by a single control; and
the output of the last first WSOS element of the plurality of first WSOS elements and the output of the last second WSOS element of the plurality of second WSOS elements are each coupled directly to the photodetector without being combined prior to the photodetector.

20. (canceled)

21. The switched wavelength optical receiver according to claim 10, wherein
one of:
the first polarisation is orthogonal to the second polarisation;
the first polarisation is the same as the second polarisation;
each first WSOS element of the plurality of first WSOS elements is configured between a first state and a second state offset by fifty percent of the FSR of that first WSOS of the plurality of first WSOS elements by a single control;
each second WSOS element of the plurality of second WSOS elements is configured between a first state and a second state offset by fifty percent of the FSR of that second WSOS of the plurality of second WSOS elements by a single control; and
the output of the last first WSOS element of the plurality of first WSOS elements and the output of the last second WSOS element of the plurality of second WSOS elements are combined prior to the photodetector.

22. (canceled)

23. The switched wavelength optical receiver according to claim 10, wherein
a first subset of the plurality of first WSOS elements have a first configuration and a second subset of the plurality of first WSOS elements have a second configuration;
a first subset of the plurality of second WSOS elements have a first configuration and a second subset of the plurality of second WSOS elements have a second configuration; and
the FSRs of the first subset of the plurality of first WSOS elements are the same as the FSRs of the first subset of the plurality of second WSOS elements.

24. The switched wavelength optical receiver according to claim 10, wherein
a first subset of the plurality of first WSOS elements have a first configuration and a second subset of the plurality of first WSOS elements have a second configuration;
a first subset of the plurality of second WSOS elements have a first configuration and a second subset of the plurality of second WSOS elements have a second configuration;
the FSRs of the first subset of the plurality of first WSOS elements are the same as the FSRs of the first subset of the plurality of second WSOS elements;
each first WSOS of the plurality of first WSOS elements having the first configuration has a first state and a second state offset by fifty percent of the FSR of that first WSOS and employs an optical switch in conjunction with an element having a wavelength response defined in dependence upon the FSR of the first WSOS it forms part of; and
each second WSOS of the plurality of second WSOS elements having the first configuration has a first state and a second state offset by fifty percent of the FSR of that second WSOS and employs an optical switch in conjunction with an element having a wavelength response defined in dependence upon the FSR of the second WSOS it forms part of.

25. A method comprising:
providing a polarisation element for generating a first output with a first polarisation and a second output with a second polarisation;
providing a plurality of first wavelength selective optical switch (WSOS) elements coupled in series wherein the first WSOS element of the plurality of first WSOS elements is coupled to the first output and each sequential first WSOS in the plurality of first WSOS elements has a free spectral range (FSR) equal to the FSR of the preceding first WSOS element of the plurality of first WSOS elements multiplied by a constant;
providing a plurality of second wavelength selective optical switch (WSOS) elements coupled in series wherein the second WSOS element of the plurality of second WSOS elements is coupled to the second output and each sequential second WSOS element in the plurality of second WSOS elements has an FSR equal to the FSR of the preceding second WSOS element of the plurality of second WSOS elements multiplied by the constant;
providing a photodetector; and
selectively coupling an incoming optical signal of a plurality of optical signals at predetermined wavelengths coupled to the polarisation element to the photodetector in dependence upon establishing each first WSOS element of the plurality of first WSOS elements into one of a first state and a second state and establishing the corresponding second WSOS element of the plurality of second WSOS elements into the same one of the first state and the second state; wherein
an output of the last first WSOS element of the plurality of first WSOS elements is coupled to the photodetector;
an output of the last second WSOS element of the plurality of second WSOS elements is coupled to the photodetector; and
each first WSOS element of the plurality of first WSOS elements and each second WSOS element of the plurality of second WSOS elements passes a first subset of those wavelengths coupled to it in the first state and a second subset of those wavelengths coupled to it in the second state.

26. The method according to claim 25, wherein
one of:
the constant is either 0.5 or 2.0; and
the constant is either 0.5 or 2.0 and the predetermined portion is 50%.

27. The method according to claim 25, wherein
the predetermined wavelengths of the plurality of optical signals are defined upon a grid having a channel spacing equal to half that of the smallest FSR;
the first state and the second state within each first WSOS element of the plurality of first WSOS elements and each second WSOS element of the plurality of second WSOS elements are offset by a predetermined portion of the FSR of that first WSOS element of the plurality of first WSOS elements or second WSOS element of the plurality of second WSOS elements.

28. (canceled)

29. The method according to claim 25, wherein
one of:
each first WSOS element of the plurality of first WSOS elements and each second WSOS element of the plurality of second WSOS elements comprises an optical de-interleaver (D-INT) having a pair of outputs and a waveguide based optical switch (OS) coupled to the pair of outputs of the D-INT;
each first WSOS element of the plurality of first WSOS elements and each second WSOS element of the plurality of second WSOS elements comprises an optical de-interleaver (D-INT) having a pair of outputs and a microelectromechanical systems (MEMS) based optical switch (OS) coupled to the pair of outputs of the D-INT;
each first WSOS element of the plurality of first WSOS elements and each second WSOS element of the plurality of second WSOS elements comprises a Mach-Zehnder interferometer (MZI) based optical de-interleaver (D-INT) and a MZI based optical switch (OS);
each first WSOS element of the plurality of first WSOS elements and each second WSOS element of the plurality of second WSOS elements comprises a Mach-Zehnder interferometer (MZI) based optical de-interleaver (D-INT) and a microelectromechanical systems (MEMS) based optical switch (OS);
in the first state the OS selects an output of the pair of outputs of the D-INT; and
in the second state the OS selects the other output of the pair of outputs of the D-INT.

30-32. (canceled)

33. The method according to claim 25, wherein
each WSOS element of a first subset of the plurality of WSOS elements comprises a Mach-Zehnder interferometer (MZI) based optical de-interleaver (D-INT) and a MZI based optical switch (OS);
each WSOS element of a second subset of the plurality of WSOS elements comprises a Mach-Zehnder interferometer (MZI) based optical de-interleaver (D-INT) and a microelectromechanical systems (MEMS) based optical switch (OS);
in the first state of each WSOS of the plurality of WSOS elements the OS selects an output of the pair of outputs of the D-INT; and
in the second state the OS selects the other output of the pair of outputs of the D-INT.

34. The method according to claim 25, wherein
the constant is either 0.5 or 2; and
the second subset of wavelengths passed by each first WSOS element of the plurality of first WSOS elements or each second WSOS element of the plurality of second WSOS elements are offset with respect to those wavelengths passed in the first state by 50% of the FSR of that first WSOS element of the plurality of first WSOS elements or second WSOS element of the plurality of second WSOS elements.

35. The method according to claim 25, wherein
one of:
the first polarisation is orthogonal to the second polarisation; and
the first polarisation is the same as the second polarisation;
each first WSOS element of the plurality of first WSOS elements is configured between a first state and a second state offset by fifty percent of the FSR of that first WSOS of the plurality of first WSOS elements by a single control;
each second WSOS element of the plurality of second WSOS elements is configured between a first state and a second state offset by fifty percent of the FSR of that second WSOS of the plurality of second WSOS elements by a single control; and
the output of the last first WSOS element of the plurality of first WSOS elements and the output of the last second WSOS element of the plurality of second WSOS elements are each coupled directly to the photodetector without being combined prior to the photodetector.

36. (canceled)

37. The method according to claim 25, wherein
one of:
the first polarisation is orthogonal to the second polarisation; and
the first polarisation is the same as the second polarisation;
each first WSOS element of the plurality of first WSOS elements is configured between a first state and a second state offset by fifty percent of the FSR of that first WSOS of the plurality of first WSOS elements by a single control;
each second WSOS element of the plurality of first second WSOS elements is configured between a first state and a second state offset by fifty percent of the FSR of that second WSOS of the plurality of second WSOS elements by a single control; and
the output of the last first WSOS element of the plurality of first WSOS elements and the output of the last second WSOS element of the plurality of second WSOS elements are combined prior to the photodetector.

38. (canceled)

39. The method according to claim 25, wherein
a first subset of the plurality of first WSOS elements have a first configuration and a second subset of the plurality of first WSOS elements have a second configuration;
a first subset of the plurality of second WSOS elements have a first configuration and a second subset of the plurality of second WSOS elements have a second configuration; and
the FSRs of the first subset of the plurality of first WSOS elements are the same as the FSRs of the first subset of the plurality of second WSOS elements.

40. The method according to claim 25, wherein
a first subset of the plurality of first WSOS elements have a first configuration and a second subset of the plurality of first WSOS elements have a second configuration;
a first subset of the plurality of second WSOS elements have a first configuration and a second subset of the plurality of second WSOS elements have a second configuration;
the FSRs of the first subset of the plurality of first WSOS elements are the same as the FSRs of the first subset of the plurality of second WSOS elements;
each first WSOS element of the plurality of first WSOS elements having the first configuration has a first state and a second state offset by fifty percent of the FSR of that first WSOS and employs an optical switch in conjunction with an element having a wavelength response defined in dependence upon the FSR of the first WSOS it forms part of; and
each second WSOS element of the plurality of second WSOS elements having the first configuration has a first state and a second state offset by fifty percent of the FSR of that second WSOS and employs an optical switch in conjunction with an element having a wavelength response defined in dependence upon the FSR of the second WSOS it forms part of.

41. A switched wavelength optical receiver comprising:
an input port for receiving a plurality of N channels having a channel spacing of S GHz coupled to a first stage of a plurality of M stages of WSOS elements;
a photodetector coupled to the last stage of the plurality of M stages of WSOS elements; and
the plurality of M stages of WSOS elements for selecting a channel from the plurality of N channels; wherein
M and N are positive integers;
$$M = log 2 ( N ) ;$$
the first stage of the plurality of M stages of WSOS elements comprises a WSOS element having a FSR of S·R GHz where R=2\hat{ }I and I=1;
each of the M−1 remaining stages of the plurality of M stages of WSOS elements follow a predetermined sequence wherein each comprises a WSOS element having an FSR of S·R GHz where R=2\hat{ }I and I=2, . . . , M; wherein
the predetermined sequence is one where the sequence of I through the M−1 remaining stages of the plurality of M stages of WSOS elements is non-sequential.
